(19) United States
(12) Patent Application Publication
(10) Pub. No.: US 2007/0255685 A1
(43) Pub. Date: Nov. 1, 2007

(54) Method and system for modelling data

(76) Inventors: Geoffrey M. Boult, Henbury (GB); Mark Laridon, Downend (GB); Trevor E. Hilder, Trowbridge (GB); David C. Elliott, Trowbridge (GB); Daniel Johnson, Frome (GB)

Correspondence Address: JOHN BRUCKNER, P.C., P.O. BOX 490, FLAGSTAFF, AZ, 86002, US

(21) Appl. No.: 11/415,871

(22) Filed: May 1, 2006

(51) Int. Cl. G06F 17/30

(52) U.S. Cl. 707/2

(57) ABSTRACT

A method and system for modelling data that provides a constrained design space in which data is modelled is described. In particular, the invention provides for a method and system for modelling data wherein any real world entity is defined as an object of some particular type within an object table or data store. Real world entities also include things like databases, relational links between entity objects, as well as link and object types themselves. Relationships between entity objects can then be defined in a separate link database or table, which references entity objects stored within the object database or table with respect to a link type, which is also stored within the object database or table. Representing the data to be modelled within this way leads to the existence of an object hierarchy, which enables a system to define its own definitions. Moreover, since any data will be modelled within the same format, the design space is constrained, and hence it is easy to adapt a database in a format according to the present invention so as to enhance functionality, as well as to use generic software tools between different databases.

### TECHNICAL FIELD

The present invention relates to a method and system for modelling data within a database, and in particular to a method and system which provides for data to be modelled in a generic and uniform manner.

### BACKGROUND OF THE INVENTION AND PRIOR ART

The modern world is highly dependent upon reliable and rapid storage and retrieval of large quantities of data stored on computer networks. The present usual method for carrying this out is to store the data on networks of computers, accessed either by “client/server computing”, or directly across the network to the user using “thin-client computing”. These technologies are mature and robust, but the method of storing and retrieving the data presently relies on relational databases, most of which use the SQL language to design the databases, and to carry out the storage and retrieval processes.

The relational database model (RDM) was invented in 1970 by Edgar Codd while working for IBM. An example relational database model representation of data is shown in FIG. 1, described in more detail next.

FIG. 1 illustrates an example relational database model modelling the following example data. A company, Company X Limited, has three employees, Fred, Arthur and Bob. They live at 1 Example Road, 2 Specimen Street, and 3 Illustration Drive respectively. Each has a company car, being a Ford Focus, a Vauxhall Vectra, and a Ford Mondeo respectively. The respective costs of the cars were £8,000, £10,000, and £12,000, and they were each last serviced on 1st Mar. 2004, 1st May 2004, and 1st Jul. 2004 respectively. A possible RDM representation of this data is shown in FIG. 1.

Here, a first table 10 is provided containing data concerning the company, Company X Limited. A second table 12 is also provided, in which the names of the employees Fred, Arthur, and Bob, are stored, referenced to the company ID of Company X, stored in the company table 10. A further table 16 is provided in which the details of the various company cars are stored, indexed to the employee table 12. A further table 18 stores address details for the employees, but a link table 14 is required to link the address IDs stored within the address table 18 with the employee IDs used to index the employee table 12.

It should be noted that the choice of table and column names is entirely arbitrary, and another programmer might come up with a completely different structure to that shown within FIG. 1. It should also be noted that the data structure—that is, the inherent relationship between types of data—is embedded within the table and column structure of the tables 10 to 18. Moreover, within the RDM representation, “key columns” can be of integer or alphanumeric types, and it should be further noted that the “ad_emp_link” table has to have column types that match the key columns in the employee and address tables.

In addition to the above, within an RDM, metadata, that is data which models the internal structure of the table representation itself, is stored in special tables, as shown in FIG. 2. It should be noted that FIG. 2 represents a small sample of the metadata that is stored in a Microsoft® SQL Server RDM database representing the data set described previously.

In view of the above description of an example RDM database, several problems become apparent. Firstly, as mentioned previously RDM databases expect the developer (usually a database programmer) to create tables whose names and column names reflect real world objects. In order for the end user to interact with the data, a programmer has to build a software interface that connects directly with those named tables and columns. From this it follows that any alterations to the task that the system is required to perform will usually involve changing the structure of the database. If that is so then the user interface program will almost certainly need rewriting in addition.

It further follows that the “design space” within which those designing standard RDM databases can work is unbounded. The significant consequence of this is that there are as many possible solutions to a modelling problem as can be thought of, leading to a proliferation of styles, systems, and programs, none of which have any inherent requirements to be capable of being connected to any other. Moreover, given this freedom of design using an RDM database, the unique identity of an object is often found in different forms in different tables, or sometimes in the combination of identifiers from other tables (“composite keys”), and hence the maintenance and recognition of identity of objects is a further problem.

In conclusion, therefore, whilst the unbounded design space of the known relational database model provides flexibility of system design, this flexibility inherently creates further problems for maintaining and updating the database, for example so as to add functionality or other support features. The present invention is intended to address at least some of the above-described problems.

Alternatives to the relational database model are known already in the art, and WO 00/29980 describes an alternative model, referred to as the associative model, which stores data as a web of items, relationships between items, relationships between relationships and items, and relationships between relationships and relationships. Using such a model it is possible to reuse applications with different databases, merge databases easily, and store data about a wide variety of items without restraints inherent in the relational model. However, the ability to model the above relationships allows for a looseness of definition which, in turn, means that the modelling of such relationships is not bounded and therefore not generic. As a consequence, the associative database model can possess the same problems in this respect as the relational database model discussed above.

### SUMMARY OF THE INVENTION

The present invention addresses or alleviates the above-described problems by the provision of a method and system for modelling data that provides a constrained design space in which data is modelled. In particular, the present invention provides for a method and system for modelling data wherein any real world entity is defined as an object of some particular type within an object table or data store. Real world entities also include things like databases, relational links between entity objects, as well as link and object types themselves. Relationships between entity objects can then be defined in a separate link data store, which references entity objects stored within the object data store with respect to a link type, which is also stored within the object data store. Representing the data to be modelled within this way leads to the existence of an object hierarchy, which enables a system to define its own definitions. Moreover, since any data will be modelled within the same format, the design space is constrained, and hence it is easy to adapt a database in a format according to the present invention so as to enhance functionality, as well as to use generic software tools between different databases.

In view of the above, according to a first aspect of the present invention there is provided a data modelling method for storing data in a database, comprising storing a plurality of data objects, each data object representing one of a group comprising: a type of entity to be modelled; an instance of an entity to be modelled; and a type of relationship between entities to be modelled; wherein each data object includes at least the same sub-set of at least one or more properties.

By including within each object irrespective of the type of the object at least the same sub-set of one or more properties then generic software tools and routines can be written specially adapted to operate on the object properties, which tools and routines may then be used in different applications. This results in reduced programming costs and improved efficiency in producing applications using the data modelling method. Moreover, by having the same sub-set of properties for each object the database can be extended (for example to model further data) without requiring a change in database structure.

Within an embodiment of the invention the sub-set of properties includes at least a name of the object. Additionally, within the embodiment the sub-set of properties may also include at least an identity of the object. By including the identity of the object in each object in the same format the advantage is obtained that objects can be classified or subject to new classifications without rebuilding the database, and hence changes in the structure of the database can be easily achieved. Within the embodiment the identity of the object is uniquely defined.

In an embodiment of the invention the sub-set of properties includes at least a type of the object, and preferably the type of the object is defined by reference to one of the data objects representing a type of entity to be modelled. In this way the database model becomes self-referential.

Additionally, within the embodiment the type of at least one of the data objects representing a type of entity to be modelled is defined by reference to one of the data objects representing a type of entity to be modelled, whereby a hierarchical arrangement of object types is defined and stored.

Moreover, embodiments of the invention also include storing link objects defining instances of types of relationships between entities to be modelled, said link objects including at least the same sub-set of at least one or more properties. This allows relationships between entities to be modelled. Preferably the link object properties include at least: a link identity; a link type; and an indication of data objects representing the entities for which the relationship therebetween is modelled by the link object. Moreover, the link type is preferably defined by reference to one of the data objects representing a type of relationship between entities to be modelled, and preferably the indication of data objects comprises the data object identities of the data objects representing the entities for which the relationship therebetween is modelled by the link object.

Within embodiments of the invention the entities to be modelled preferably include data storage arrangements in which said data objects and/or said link objects are stored, whereby an internal structure of said database is modelled. This allows use of the database modelling method for other purposes such as integration or migration of other legacy databases.

Moreover, embodiments of the invention preferably store meta-data concerning said data storage arrangements as said data objects and/or link objects. This allows the database to completely model its own internal structure in the same format as data to be modelled, thus providing for efficient re-use of generic software tools and routines adapted to handle the format of the objects.

Preferably, within embodiments of the invention the data objects are stored within a data storage arrangement of a first type, the method further comprising instantiating data storage arrangements of a second type to store further object-specific properties of the data objects. Thus where objects have further properties which are specific or distinct to those objects, the properties are stored within further data structures.

Additionally, within embodiments of the invention the link objects are preferably stored within a data storage arrangement of a third type, the method further comprising instantiating data storage arrangements of a second type to store further object-specific properties of the link objects. Thus link objects are stored separately from other objects, and may also have further specific properties, which are stored in the same way as further properties of other objects.

Finally, within embodiments of the invention preferably the data storage arrangement of the first type and/or the data storage arrangement of the second type and/or the data storage arrangement of the third type is a database table. This allows a database modelled in accordance with the invention to be implemented using standard RDM software tools, such as Microsoft® SQL Server.

From a second aspect the invention further provides a database operating method comprising: modelling data in a database according to the method of the first aspect; and applying generic database query operations to said database to retrieve data therefrom in response to a database query. Thus, generic software tools and routines can be used in operation with such a database, regardless of the data which is being modelled. This leads to cost savings and standardisation of design in producing databases for different applications.

From a further aspect there is also provided a method of generating a visual display of data stored in a database, comprising the steps of:- modelling data in a database according to the method of the first aspect; using the link objects, generating a graphical display of data icons representing data objects indicated by said link objects, said graphical display including graphical links linking said data icons; and displaying said graphical display on a display means.

Thus the third aspect provides for easy visualisation of data stored within a database modelled according to the first aspect on a display screen.

Preferably, the graphical display is arranged as a hierarchical tree of data icons representing said data objects. This provides a familiar hierarchical view of the data, akin to a common file structure, and hence may easily be understood by a user.

From a further aspect there is also provided a method of integrating data relating to the same entity and stored within two or more databases, comprising the steps of:- modelling the data in each database according to the method of the first aspect; storing a link object defining a relationship between respective data objects instancing the data in each database relating to the same entity; and using the link object, retrieving data relating to the same entity from each database.

Thus, from such a fourth aspect the database modelling method of the first aspect may be used to integrate data contained within two or more legacy databases to provide, for example, a unified view of the data, or to allow data from each database to be subject to the same processing routine.

From a fifth aspect there is also provided a method of incrementally transferring data from a database of a first type to a database of a second type, the database of the second type being arranged to model data in accordance with the method of the first aspect, the method comprising: storing a data object within the database of the second type for each entity for which data is stored in the database of the first type; storing, within the database of the second type, a foreign key property for each data object to permit access to records within the database of the first type; and storing, within the database of the second type, further properties for each data object, the further properties corresponding to data relating to each entity stored within the database of the first type; wherein said further properties are stored within said database of the second type as the data represented by the properties is changed. Thus, the fifth aspect provides for the incremental migration of data from a legacy database into a new database modelled in accordance with the first aspect, whilst still permitting applications which make use of the data to access either the legacy database or the new database as appropriate. By such an incremental migration the risks and drawbacks of performing a “big-bang” migration where operation is suddenly and completely switched from the legacy database to the new database are avoided.

From a sixth aspect there is further provided a computer program or suite of computer programs arranged such that when executed by a computer system it/they cause the computer system to perform the method of any of the preceding aspects. Additionally, from a seventh aspect there is also provided a computer readable storage medium storing a computer program or at least one of the suite of computer programs according to the sixth aspect. The computer readable storage medium may be any such storage medium known in the art, such as a hard disk, and floppy disk, a CD, a DVD, a Zip drive, solid state memory, or the like.

In addition to the above, from an eighth aspect there is also provided a data modelling system for storing data in a database, comprising means for storing a plurality of data objects, each data object representing one of a group comprising: a type of entity to be modelled; an instance of an entity to be modelled; and a type of relationship between entities to be modelled; wherein each data object includes at least the same sub-set of at least one or more properties. The system of the eighth aspect provides the same advantages and further features and advantages as the first aspect discussed above mutatis mutandis.

From a further aspect, the invention also provides a database control system arranged in use to: i) model data in a database according to the method of the first aspect ii) apply generic database query operations to said database to retrieve data therefrom in response to a database query. The system of this further aspect provides the same advantages and further features and advantages as the second aspect discussed above mutatis mutandis.

From another aspect of the invention there is also provided a system for generating a visual display of data stored in a database, comprising:- database control means arranged in use to model data in a database according to the method of the first aspect; and graphical display means arranged in use to:- i) using the link objects, generate a graphical display of data icons representing data objects indicated by said link objects, said graphical display including graphical links linking said data icons; and ii) display said graphical display on a display means. The system of this tenth aspect provides the same advantages and further features and advantages as the third aspect discussed above mutatis mutandis.

In a yet further aspect, the invention provides a system for integrating data relating to the same entity and stored within two or more databases, comprising:-i) database control means arranged in use to model the data in each database according to the method of the first aspect; and ii) link storing means for storing a link object defining a relationship between respective data objects instancing the data in each database relating to the same entity; said database control means being further arranged in use to retrieve data relating to the same entity from each database using the link object. The system of this further aspect provides the same advantages and further features and advantages as the fourth aspect discussed above mutatis mutandis.

Finally, in a twelfth aspect the invention also provides a system for incrementally transferring data from a database of a first type to a database of a second type, the database of the second type being arranged to model data in accordance with the method of the first aspect, the system comprising: database control means arranged in use to:- i) store a data object within the database of the second type for each entity for which data is stored in the database of the first type; ii) store, within the database of the second type, a foreign key property for each data object to permit access to records within the database of the first type; and iii) store, within the database of the second type, further properties for each data object, the further properties corresponding to data relating to each entity stored within the database of the first type; wherein said further properties are stored within said database of the second type as the data represented by the properties is changed. The system of the twelfth aspect provides the same advantages and further features and advantages as the fifth aspect discussed above mutatis mutandis.

### BRIEF DESCRIPTION OF THE DRAWINGS

Further features and advantages of the present invention will become apparent from the following description of embodiments thereof, presented by way of example only, and by reference to the accompanying drawings, wherein like reference numerals refer to like parts, and wherein:—

FIG. 1 is an illustration of an example relational database model of the prior art;

FIG. 2 are tables containing metadata from the RDM representation of FIG. 1;

FIG. 3 is a block diagram of a computer system embodying the present invention;

FIG. 4 is a flow diagram of steps performed in a first embodiment of the present invention;

FIG. 5 is an object table used for explaining the first embodiment of the present invention;

FIG. 6 is an object table used for explaining the first embodiment of the present invention;

FIG. 7 is an object table used for explaining the first embodiment of the present invention;

FIG. 8 is an object table used for explaining the first embodiment of the present invention;

FIG. 9 is an object table used for explaining the first embodiment of the present invention;

FIG. 10 is a link table used for explaining the first embodiment of the present invention;

FIG. 11 is a link table used for explaining the first embodiment of the present invention;

FIG. 12 is an object table used for explaining the first embodiment of the present invention;

FIG. 13 is an object table used for explaining the first embodiment of the present invention;

FIG. 14 is an illustration representing an example database in accordance with the first embodiment of the present invention;

FIG. 15 is a link table of the example used for explaining the first embodiment of the present invention;

FIG. 16 is an extended view of the link table of the example of the first embodiment of the present invention;

FIG. 17 is a flow diagram illustrating the steps involved in generating a graphical view of data modelled in accordance with the first embodiment of the present invention;

FIG. 18 is a graphical view of data modelled in accordance with the first embodiment of the present invention;

FIG. 19 is a system diagram illustrating a second embodiment of the present invention;

FIG. 20 is a flow diagram illustrating steps involved in a second embodiment of the present invention;

FIG. 21 is an illustration of legacy database tables used within the second embodiment of the present invention;

FIG. 22 is an illustration of the object and property data stores links to a legacy database table used within the second embodiment of the present invention;

FIG. 23 is an illustration of tables from legacy databases used within the second embodiment of the present inventions;

FIG. 24 is an illustration of tables within a legacy database used within the second embodiment of the present invention;

FIG. 25 is a graphical view of data modelled according to the second embodiment of the present invention;

FIG. 26 is a graphical view of data modelled in accordance with the second embodiment of the present invention;

FIG. 27 is a screen shot of a graphical user interface illustrating the retrieval of data within the second embodiment of the present invention;

FIG. 28 is a screen shot of a graphical user interface illustrating retrieval of data within the second embodiment of the present invention;

FIG. 29 illustrates link and object tables used within the second embodiment of the present invention;

FIG. 30 is an illustration of an object table used within the second embodiment of the present invention;

FIG. 31 is an illustration of a property table used within the second embodiment of the present invention;

FIG. 32 is a screen shot of a graphical view provided by the second embodiment of the present invention; and

FIG. 33 is a screen shot of a graphical view provided as output of the second embodiment of the present invention;

FIG. 34 is a system block diagram of a further embodiment of the present invention;

FIG. 35 is a flow diagram illustrating steps performed within the third embodiment of the present invention;

FIG. 36 is a flow diagram illustrating steps performed within a third embodiment of the present invention;

FIG. 37 is a flow diagram illustrating steps performed within the third embodiment of the present invention;

FIG. 38 is an illustration of various tables used within the third embodiment of the present invention; and

FIG. 39 is an illustration of various tables used within the third embodiment of the present invention.

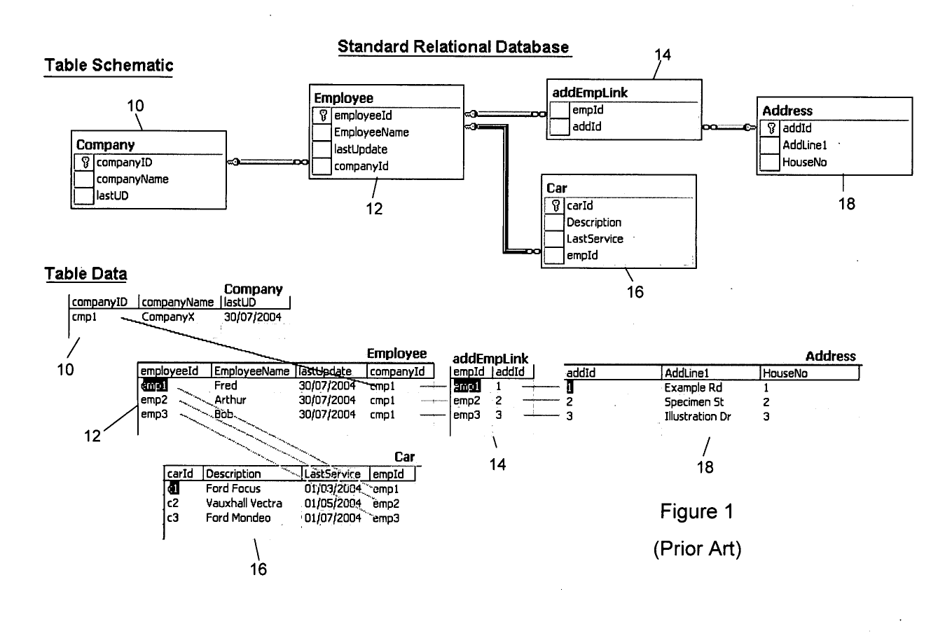

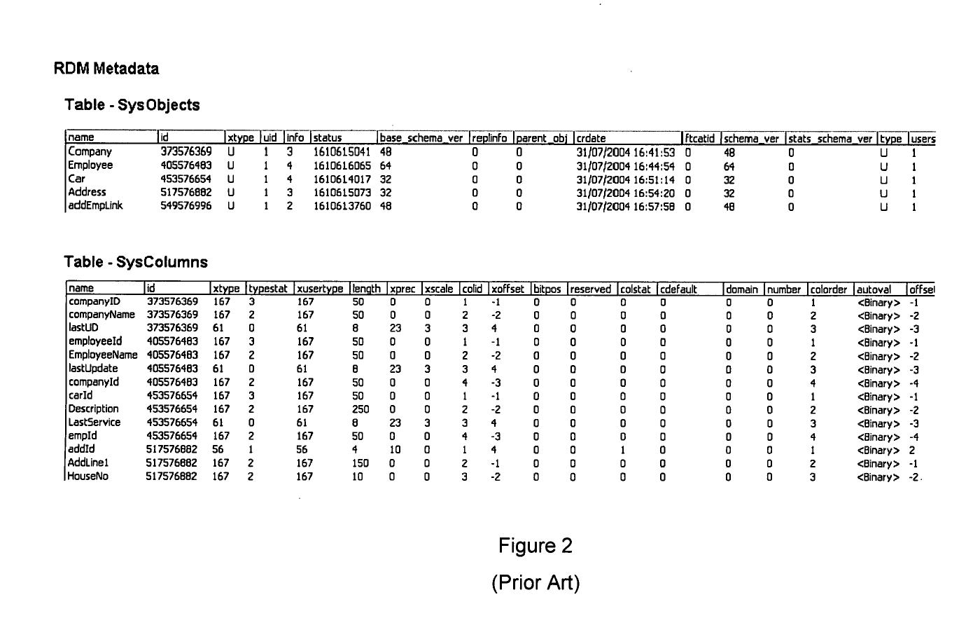

### DESCRIPTION OF THE EMBODIMENTS

A first embodiment of the present invention will now be described. The first embodiment of the present invention provides a method and system for modelling data, which we refer to herein as the “Universal Database Model” (UDM). The UDM assumes that there are five universally applicable properties of any real world object that needs to be represented within a database. These are:—
1. Name—semantic content;
2. Identity—unique identification;
3. Type—classifying objects into types;
4. Process/Temporal Mapping—time stamping, sequencing, or ordering; and
5. Relationships—naming and identification of relationships between objects.

Within the UDM these features of real world objects to be modelled do not necessarily have to be “stored” in the same way or in the same place as each other. In particular, the naming, identity, and type properties of an object are stored within the UDM in a first data storage arrangement or “data store” that we refer to as the object data store. Additionally, part of the process/temporal mapping information, such as time stamping, may also be stored in the object data store. The remaining fundamental properties are stored in a link data store, and in particular, the time stamping, sequencing, and ordering properties of the process/temporal mapping, and the naming and identification of relationships between objects.

In addition to the above five universal properties of an object representing a real world entity, any object or relationship may have additional properties which are stored in supplementary data stores, called “property” or “child” data stores. Examples of “property” or “child” data stores will become apparent from the embodiments to be described.

The concept of a “data store” as used within the specific description should also be further defined. More particularly, by the term “data store” we merely mean a means of storing many groups of uniform data (data tuples), each of which has an identity and a series of attributes. A collection of stored data tuples may be retrieved by specifying the values of identities or attributes which in some manner match those in the data tuples.

With such a definition, a data store may preferably have within it mechanisms to guarantee that a data tuple which has been put into it cannot be lost. Additionally, a data store will preferably include features which enable the rapid retrieval of a collection of data tuples, based on such selection criteria. These mechanisms may distribute the data across servers, across networks of servers, and store duplicate copies of the data, to ensure that a data tuple which has been stored can always be retrieved again. Such mechanisms already exist (e.g. clustering, RAID systems). From our point of view, what matters is that a data tuple with a unique identity can be stored and retrieved again. How this is done is a matter of implementation detail, and is of no concern to the UDM, other than that it works efficiently for practical purposes.

As an example of known arrangements which may implement a data store within the meaning ascribed herein, within the RDM, a database table is such a data store a column with primary key constraint is such an identity, a column without primary key constraint is such an attribute, and a row within a table is such a data tuple. In one of its simplest embodiments, therefore, a data store may be no more than a database table, and such example is used as the illustrative, but non-limiting, example in the remainder of the description. Other non-table based data storage arrangement may also be utilised; by use of the term we mean only some arrangement which is able to store data tuples in a reliable and retrievable manner.

Moreover, a collection of related data stores may be referred to as a database. Our use of this term does not assume that there has to be a fixed relationship between a database and a collection of data stores. Data stores may be arbitrarily assigned to a database for a particular purpose, then grouped differently for a different purpose.

Axiomatic to the UDM theory is the principal that everything in the real world can be defined as an object of some type. Thus, every entity which is to be modelled as an object within the UDM must first have its object type defined, and then have its object declared within the object data store. In addition, as well as modelling external entities as objects, an internal representation of the model may also be modelled within the same model. This includes things like databases, data stores, links, and object types themselves. This leads to the existence of an object hierarchy within the UDM that enables the system to define its own definitions. This object hierarchy will be described in more detail next.

In the above, we have mentioned that there are two basic types of object: those objects representing real world entities themselves, and links which define the relationships between those entities. In order to define different types of object and link, a UDM system needs two type defining objects: an object definition and a link definition. For ease of representation in the accompanying figures these structures are illustrated as they might be instantiated using a standard SQL relational database model.

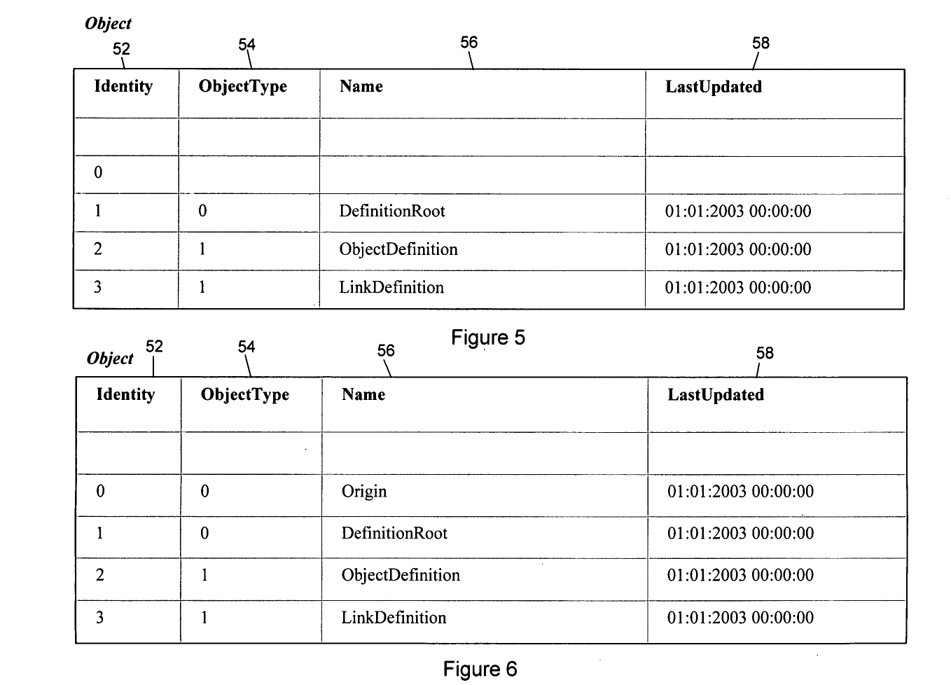

Firstly, as shown in FIG. 5, a table, or data store, is created which is called “object”. Since all objects have certain fundamental properties this table requires a small number of columns in which to store these fundamental properties. Thus, as will be seen, a first “identity” column 52 is provided in which object identifiers in the form of numbers are stored. A second “object type” column 54 is then also provided, in which are stored object identifiers which index to the object identifiers stored in the identity column 52. Additionally provided is a “name” column 56, in which object names are stored, as well as a “last updated” column 58, wherein a time stamp giving the data and time at which the object was last updated is stored.

Within table 5, three objects are illustrated. The first object of identity number “1” is the “definition root” object which is specified as being of object type “0”. Within FIG. 5, the object with object identity “0” is not shown. A second object “object definition” with identity “2” is also stored, and this is defined as being of object type corresponding to the object identity “1”, in column 54. Thus, the “object definition” object is of object type “definition root”. Similarly, a third object “link definition” is further stored, which has object identity number “3” in the object identity column 52, and is further defined in the object type column 54 as being of object type object identity “1”. Therefore, the object “link definition” is also of type “definition root”. It should be noted that the object definition and link definition objects are specified as being the same type as each other, namely the root of all definitions.

FIG. 6 illustrates a more complete object data store, wherein a further object of object identity “0”, is defined. This object is the origin object, of which the object “definition root” is of the type. To avoid an infinite regression of definitions, we stipulated that the object “origin” itself is of its own type. FIGS. 5 and 6 therefore represent the absolute upper level of the object hierarchy, and provide type definitions which objects at the next level in the hierarchy can use to type themselves.

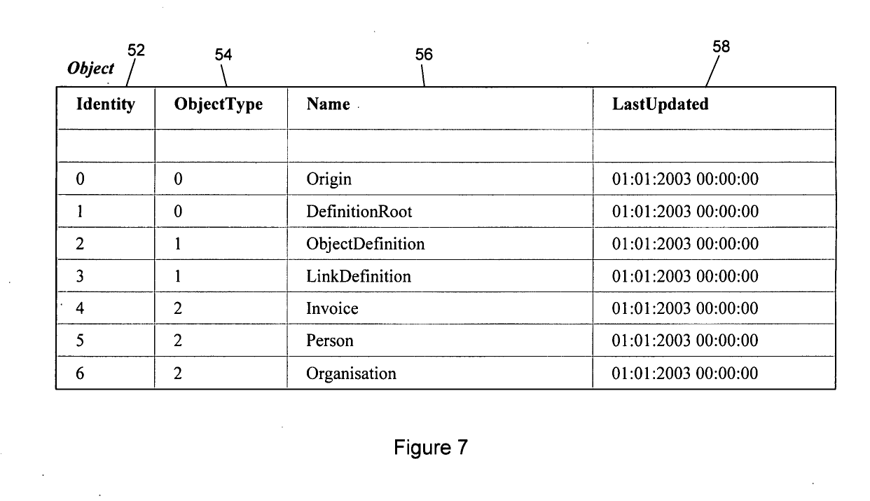

FIG. 7 illustrates objects representing real world entities stored in the object data store at the next level in the hierarchy. These objects may represent real world entities such as people or vehicles, or alternatively may relate to real world abstract entities such as invoices or jobs. It should be noted that there is no inherent difference at this level between an inanimate object like a vehicle and a fully conscious complex living creature like a person. The differences appear solely in the further properties associated with the type of object in question.

In FIG. 7, therefore, three additional objects have been stored within the object data store. These are the “invoice” object, which has an object identity of “4” stored in the object identity column 52, and is defined within the object type column as being object type “2”. By reference to the object with object identity “2”, it will be seen that the “invoice” object is defined as an “object definition”. Similarly, the object “person” and “organisation” have been allocated respective object identities “5” and “6” in the object identity column 52, and are also of the “object definition” type as defined by their entries in the object type column 54.

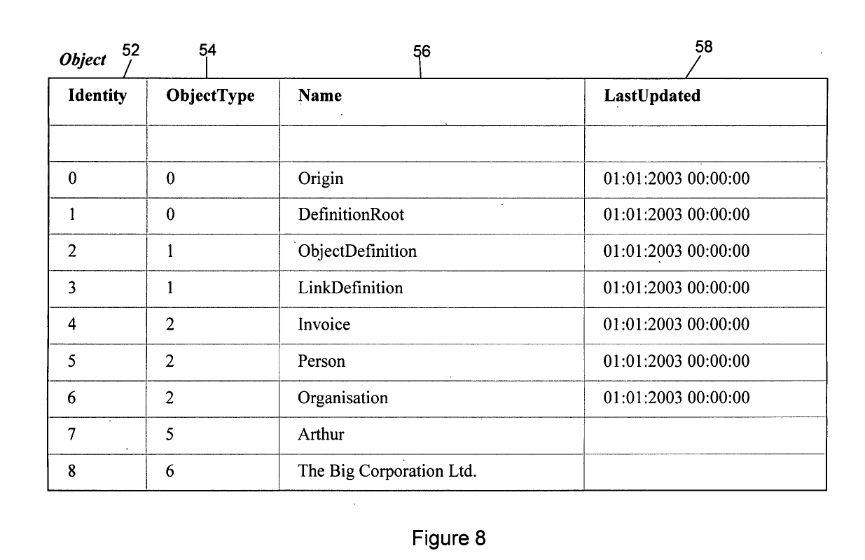

At this stage, therefore, as shown in FIG. 7 the top-level (root-level) of the hierarchy has been modelled, then a next level of hierarchical objects have also been modelled, representing types of real world entity which may be subsequently modelled. FIG. 8 illustrates instances of how actual real world entities may then be subsequently modelled. More particularly, within FIG. 8 it will be seen that an object “Arthur” with object identity “7” in the object identity column 52 has been added to the object data store. The object “Arthur” is defined in the object type column 54 as being of object type “5”. With reference to the object which has object identity “5”, it will be seen that object identity “5” is an object definition of type person. Therefore, the entry for “Arthur” as record “7” specifies that Arthur is an object of type “person”. Thus, the real world entity Arthur, being a person, is modelled within the database in a hierarchical manner as a type “person”.

Similarly, a further object “The Big Corporation Limited” is also modelled. This entry has object identity “8” in column 52 and is specified in column 54 as being of object type “6”. It will be seen from the object identity column 52 that the object with object identity “6” is an object definition of type “organisation”. Thus, the entry in record “8” represents an organisation called The Big Corporation Limited. Thus, at this point, it will be seen that two real world entities, being Arthur the person and The Big Corporation Limited being a company, have been modelled within the object data store.

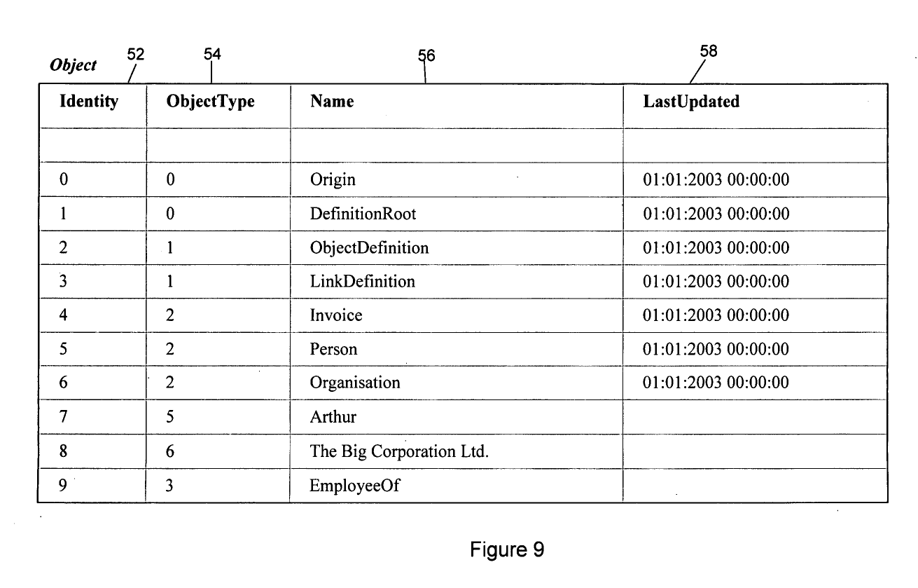

Thus far, we have described how objects representing real world entities can be stored within a hierarchical manner within the UDM. However, in order to properly represent the data to be modelled, it is also necessary to store links defining relationships between entities which are being modelled. For example, the person “Arthur” modelled as record “7” might be an employee of the organisation “The Big Corporation Limited” modelled. as record “8”. In order to represent this relationship, a link object is stored within the object data store, as shown in FIG. 9. With reference to FIG. 9, it will be seen that a new object of name “employee of” is stored with an object identity “9” in column 52, and is specified as being of object type “3” in column 54. With reference to the object identity column 52, the object with object identity “3” is a link definition. Therefore, the “employee of” object defined of being of type “link definition”, and therefore is an object that defines types of links. It should be noted that this record within the object data store is a type of link, and is not a link itself.

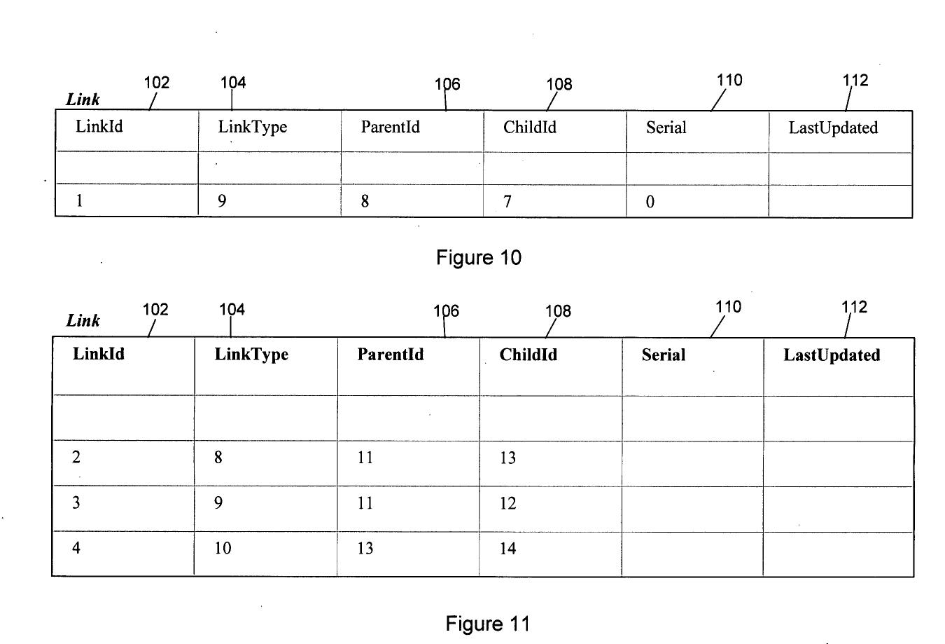

In order to store links per se, a further database table or data store is instantiated, known as the link data store. An example of a link data store is shown in FIG. 10. More particularly, a link data store comprises a link ID column 102, in which identities of links are stored. A link type column 104 is further provided, in which link type identities which index to the object identity column 52 of the object data store are stored. A “parent ID” column 106, and “child ID” column 108 are also provided, which also store object ID numbers indexed into the object identity column 52 of the object database 54. Additionally, a “serial” column 110 and a “last updated” column 112 are also provided. The “serial” column records the ordering of links related to each other in a particular context. The context is defined by the way in which a particular link type is used to relate objects and the precise significance of this property will naturally depend on the type of relationship and its use within the system. The “last updated” column stores a time stamp of when the link was last updated.

A link such as that shown within FIG. 10 represents the relationship:
[object with child ID]{relationship of link type}[object of parent ID].

Thus, for example, for the link shown in FIG. 10, with reference to FIG. 9 the link with link ID “1” is specified as being of link type “9”, which, as shown in FIG. 9, represents the “employee of” link type. Moreover, the parent ID of link “1” is specified as being object ID “8”, which indexes to the object “The Big Corporation Limited” in the object data store of FIG. 9. Similarly, the child ID within the link shown in FIG. 10 indexes to object ID “7” in the object data store of FIG. 9, which is the object “Arthur” of type “person”. Thus, the link within FIG. 10 represents the relationship:

[Arthur]{employee of}[The Big Corporation Limited].

Thus, within a few entries it is possible to model both real world entities and the relationships therebetween.

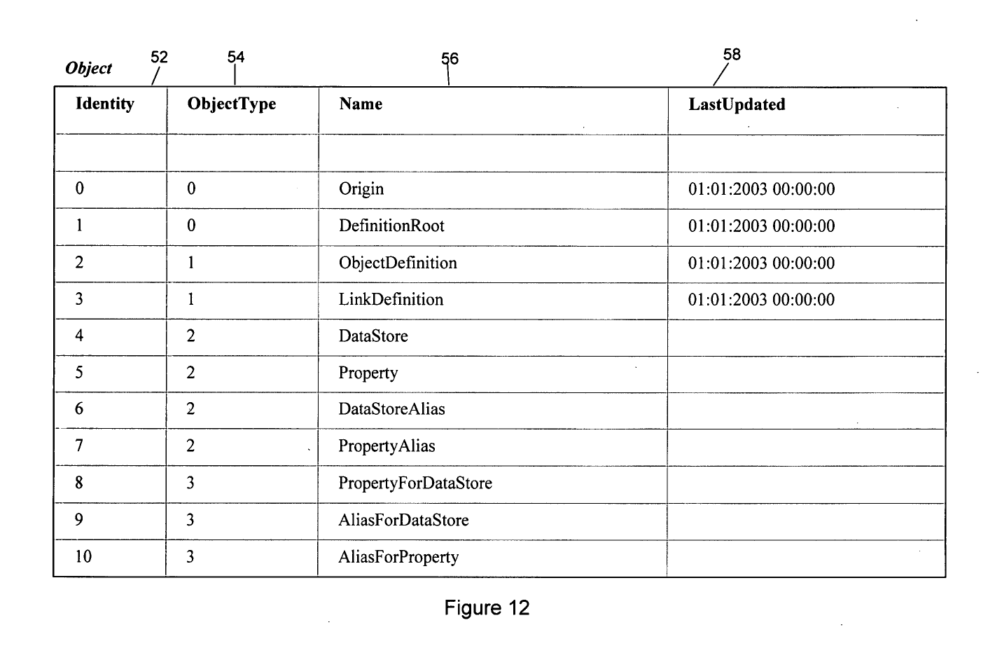

However, in a real implementation there are certain other objects and relationships to define before this stage. In particular, we stipulate that the UDM must preferably be able to model itself within itself, so some of the first object link types to be defined are those associated with the internal representation of the UDM itself. These are shown within FIG. 12. Comparing FIG. 12 to FIG. 6 discussed previously, it will be seen that several new objects need to be added to the object data store in order to allow a UDM representation to model itself. In particular, the object types “data store”, “property”, “data store alias”, and “property alias” are defined. The “property alias” and “data store alias” object types are defined to provide for human readable aliases, to allow a human programmer to review the operation of the system.

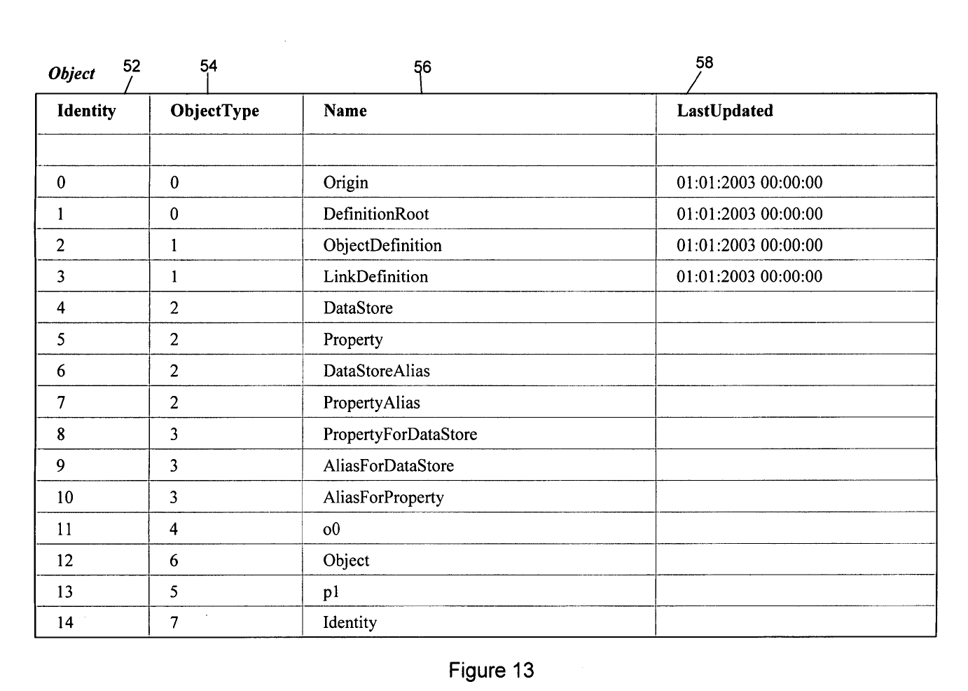

In addition to the above, three further objects defining new link types are also added. These are the “property for data store” link type, the “alias for data store” link type, and the “alias for property” link type. How these new object and link types are used will be described next with respect to FIG. 13.

In FIG. 13 a further four objects have been added to the object data store. These are object “11”, which is specified as being of object type “data store” and has name “o0”. Additionally, object “12” of name “object” and of type “data store alias” is also added. Additionally, object “13” has name “P1” and is specified of being of object type “property”. Finally, object “14” has name “identity” and is specified as being of object type “property alias”. FIG. 11 illustrates the link data store, linking the above described objects. More particularly, link “2” is specified as being of link type “8”, which, with reference to FIG. 13, can be seen to be of type “property for data store”. This link links objects “13” and “11”, which are objects “P1” and “o0”. Therefore, link “2” represents the relationship that “P1” is a property for data store “o0”.

Additionally, link “3” is of link type “9”, which, with reference to FIG. 13, can be seen to be of link type “alias for data store”. The link therefore links objects “11” (“o0”) and “12” (“object”) and hence represents as a link that the object “object” is an alias for data store “o0”. Similarly, the link “4” is of link type “10”, which it will be seen from FIG. 13 is of type “alias for property”. The link thus links objects “13” and “14” and hence represents the link that the object “identity” is an alias for property “P1”. Using link types and objects in this manner allows a UDM representation of data to model itself.

Previously, we mentioned that further properties of an object are stored in a further object database table or data store. For example, for an object of type “data store” (i.e. of type “4” with respect to FIG. 13), there is likely to be a need for a further data store to hold further properties of data stores—for instance whether they are local to the system or form part of a “foreign” database. In order to achieve this, an object “data store” is stored within the object data store, and specified as being of object type “4” which, with reference to FIG. 13 specifies the object as being of type “data store”. By storing such an object there are now two objects in the object data store with the same name “data store”. The first, whose ID here is 4, is an object type definition, whereas the second is an instance of this type, namely a data store, whose name (coincidently) is also “data store”. It is the data store that keeps data about data stores. (Incidentally, FIG. 13 also shows a further object of type “data store”, being object 11 “o0”).

In order for the UDM to know that object “15” is a data store that stores data about data stores, it is tied to the object type definition by a link of type “data store for object”. Therefore, it is necessary to define within the object data store a further link type, and this is added as object “16”, of object type “link definition”, and of name “data store for object”. Then, within the link data store a link is created, of link ID “5”, link type “16”, linking the data store object with the data store type definition. Continuing in this way the whole UDM is able to model both its own internal structure, and the other real world structures that it is required to represent. An example of such operation will be described later.

From the above description, it will be apparent that in order for objects and links to be able to refer to each other it is necessary for them to have a unique identity, at least within the context in which they are to be referenced. There is therefore a requirement for an “identity generator” program or module, responsible for generating unique identities.

An identity generator is a mechanism for creating a unique identity value which may then be assigned to a data tuple to establish its identity. Many implementations of the RDM include such a mechanism.

For example, Microsoft SQL Server allows one column within each table to be given the identity property, which means that it automatically gets a unique value whenever a row is inserted in the table. Each of this column's values is only unique within that table, but there is also a ROWGUIDCOL property which can be attached to a column of data type uniqueidentifier to ensure that every row gets a globally unique value.

The precise nature of the unique identity values does not concern the UDM—what matters is that each value is unique and that the values are represented in a manner which is efficient within the practicalities of any particular implementation. Within the examples described herein it will be seen that the identities are simple numerical values, which increase with each declared object or type definition, to ensure that each identity is unique—there is only one object with identity “7”, for example. Other, more complicated identity values may be derived.

Moreover, in some implementations, the identity generator may operate independently of the data stores, whereas in others, some data stores may contain their own identity generator. In the former case, an identity will be generated for a data tuple before it is stored, and the data store will be passed its value. In the latter case, where required, the data store will generate the identity as the data tuple is inserted in it, and will return the generated identity to the process which did the insertion. We describe this as the distinction between global identities and data store local identities.

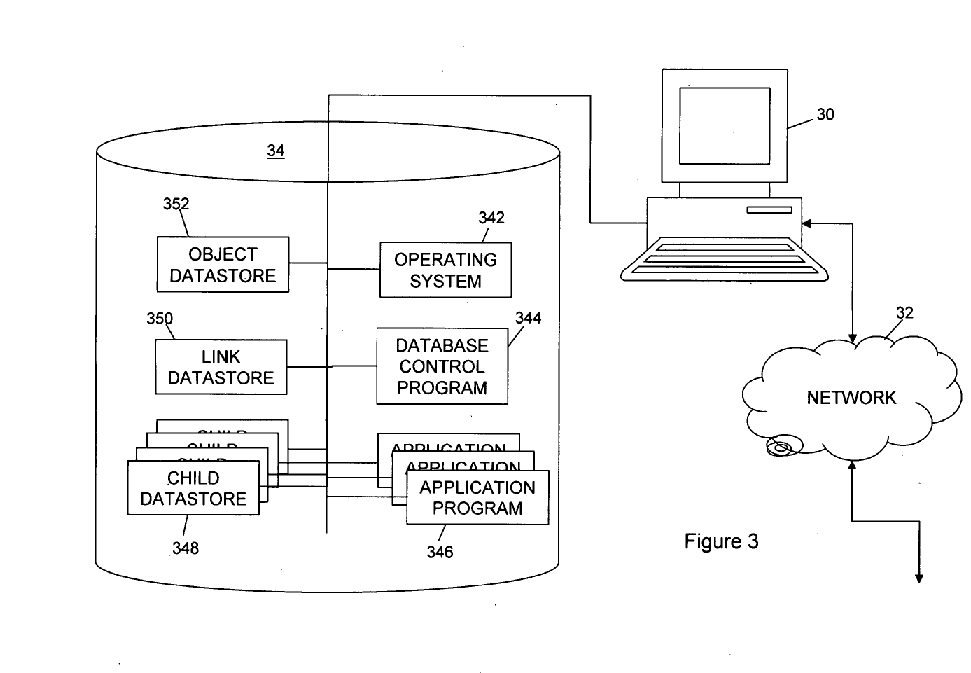

In view of the above described description of the UDM, FIG. 3 illustrates a system block diagram of a conventional computer system upon which is stored programs and data in order to allow the computer system to operate in accordance with the UDM.

More particularly, with reference to FIG. 3, a conventional computer system 30 is provided which has a computer readable storage medium 34, such as a hard disk drive, or optical disk drive, such as a DVD, or CD drive. Other data storage media are of course known in the art, which may also be used. The computer system 30 is usually provided with a connection to a network 32 such as the Internet, to allow the formation of logical connections to other computer systems. With respect to the computer readable storage medium 34, stored thereon is an operating system program 342, which controls the computer system so as to be able to perform its operations, in a conventional manner. Application programs 346 are also stored, which when executed by the computer system enable the computer system to perform tasks in accordance with instructions from a user. Example application programs are, for example, word processing programs, spreadsheet programs, browser programs, or the like. In accordance with the embodiment of the invention, however, a database control program 344 is also provided, which controls the computer system 30 to model data to be modelled in accordance with the UDM. Therefore, in accordance with this, an object data store 352 is provided in which object models representing entities to be modelled and metadata may be stored. Additionally provided is a link data store 350, in which links defining the relationship between objects stored within the object data store 352 are stored. Multiple child data stores 348 are also provided, which store properties of objects, as described previously.

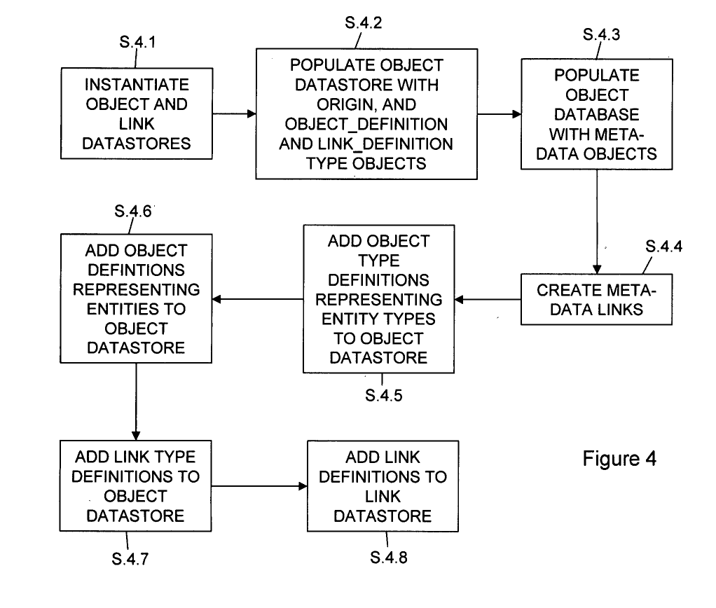

FIG. 4 is a flow diagram representing the steps performed by the computer system 30 under the control of the database control program 344, so as to model data in accordance with the UDM described previously. More particularly, at step 4.1 the computer system 30 instantiates the object and link data stores. Thus, the object data store 352 and the link data store 350 are instantiated and stored on the computer readable storage medium 34. Next, at step 4.2 the object data store is populated with origin and object definition and link definition type objects, as described previously with respect to FIGS. 5 and 6. Following this, at step 4.3, the object data store 352 is populated with metadata objects, as described previously with respect to FIG. 12. Following this, as step 4.4, the link data store 350 is populated with metadata links, as described previously with respect to FIG. 11.

Having established the object and link data stores together with the metadata therein, at step 4.5 the computer system 30 adds object type definitions representing entity types to be modelled to the object data store 352. This would be done under the control of a database programmer. Next, at step 4.6 the computer system 30 adds object definitions representing entities to be modelled to the object data store 352. Again, the computer system will perform this step under the control of a database programmer. Next, at step 4.7 link type definitions representing relationships between various object types are added to the object data store 352, and then finally, at step 4.8 link definitions representing relationships between objects contained within the object data store are added to the link data store 350. Once again, steps 4.7 and 4.8 will be performed by the computer system 30 under the control of a human programmer.

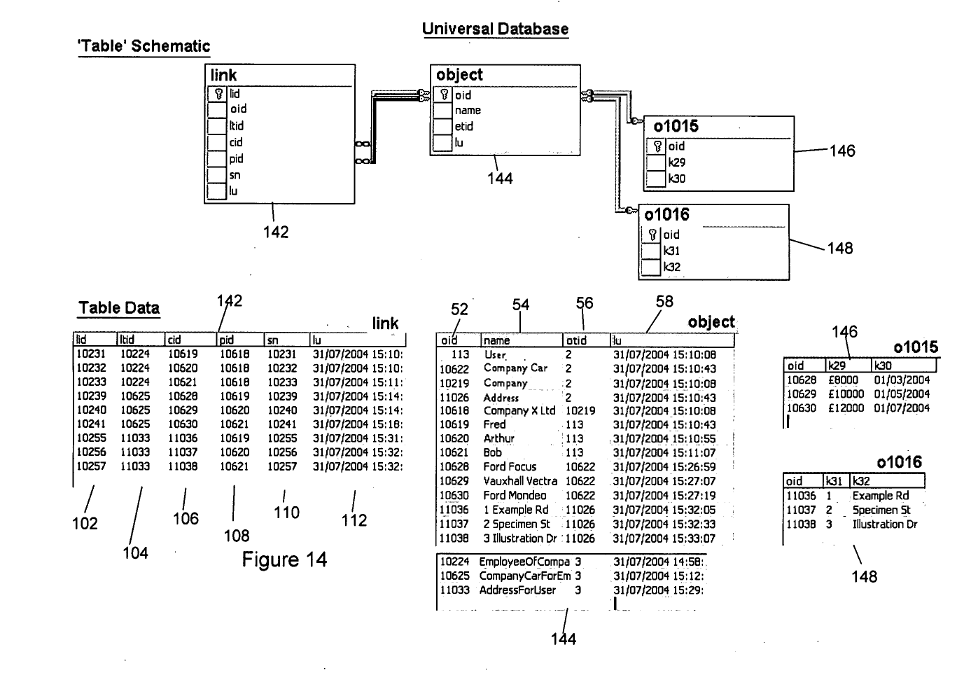

Following the above method, it is possible to model real world entities as objects within an object data store, and model the relationships therebetween as links within the link data store, as described. An example of such operation, using the data set discussed previously with respect to the prior art, will now be described with respect to FIGS. 14 to 16.

FIG. 14 illustrates a UDM representation of the previous data set, generated in accordance with the first embodiment of the present invention. More particularly, a link database table or data store 142 is provided, which stores links of particular types between specified parent and child objects. The objects themselves are defined within the object database table or data store 144, and particular properties of objects defined therein stored within the child data stores 146 and 148. In particular, the child data store 146 stores data about the company car objects, whereas the child data store 148 stores data about the address objects.

Looking at FIG. 14 more closely, and in particular the object data store 144, it will be seen that the object data store contains four object type definitions, being object ID numbers “113”, “10622”, “10219”, and “11026”. That these are object type definitions can be determined from the object type ID in column 56, which is set as type “2”. From FIG. 13 given previously, it will be recalled that object ID “2” is top level type definition for object type definitions.

Following the object type definitions, various objects themselves are declared within the object data store 144, with respect to the declared object type definitions. For example, object “10618” of name “Company X Limited” is declared to be of type “10219”, which is of course the company object type definition. Likewise, object ID “10628” of name “Ford Focus” is declared to be of type “10622”, which is the “company car” object type definition. The other objects declared within the object data store 144 can be resolved in a similar way.

Additionally stored within the object data store 144 are three link definitions, being object IDs “10224”, “10625”, and “11033”. That these are link type definitions is apparent from the object type ID in column 56, which is specified as being type “3” which corresponds to a link definition type, as shown in FIG. 13 previously.

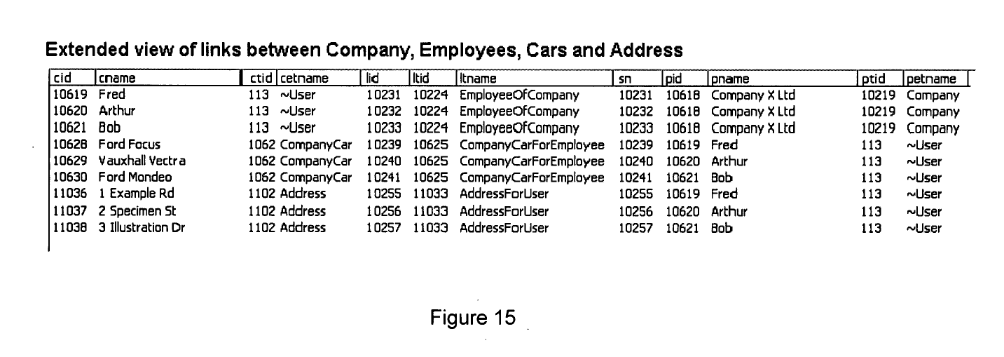

In view of the above declared objects, the link data store 142 defines link data defining relationships between the objects. More particularly, looking more closely at the link data store 142, it can be seen that each of the link type Ids are of the link types declared within the object data store 144, i.e. types “10224”, “10625”, and “11033”. FIG. 15 illustrates the link data store in more detail, wherein substituting in the data from the object data store 144 has expanded the child ID and parent ID entries in columns 106 and 108. Therefore, within FIG. 15, it can be seen that the link data store 142 stores link information representing the data set.

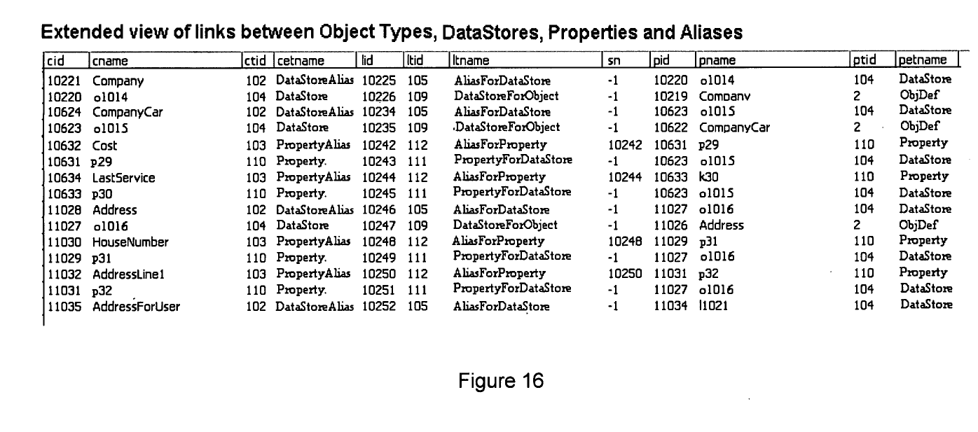

However, while the link data store 142 stores the basic information defining the relationships between the declared objects, the child data stores 146 and 148 store additional information about specific of the declared objects. In order for the system to know which of the objects each child data store relates to, data is stored defining the relationships between the child data stores 146 and 148, and the declared objects. Such metadata is stored within both the object data store and the link data store, as described previously, and FIG. 16 illustrates the link metadata which would be stored in the link data store 142. As with FIG. 15, this link data has been expanded, by substituting information from the object data store into the child ID and parent ID columns 106 and 108.

As explained and illustrated above, therefore, the UDM represents relationships between data objects in a generic manner, in contrast to conventional RDMs which use different ways of representing such relationships according to the style and practice of individual programmers. The specific structures implemented within a UDM allow it to be built on any robust industry standard relational database, allowing it to be independent of any specific database system. Furthermore, as the UDM incorporates “metadata” in the same internal object structure as all other data, it can extend that structure to accommodate changes to the data structure used to model the real world situation it is serving, using its own internal structure. This means the process of altering or extending the database can be effected by the use of automated processes.

Moreover, the UDM divides the modelling space of a database into two distinct parts: that which models objects in the real world, and that which models links between such objects. Properties that are extra to the minimum atomic list of data common to all objects are stored in child data stores of either objects or links.

In addition to providing the above described technical advantages, systems based upon the UDM also provide further features and advantages, as will be apparent from the following embodiments to be described next.

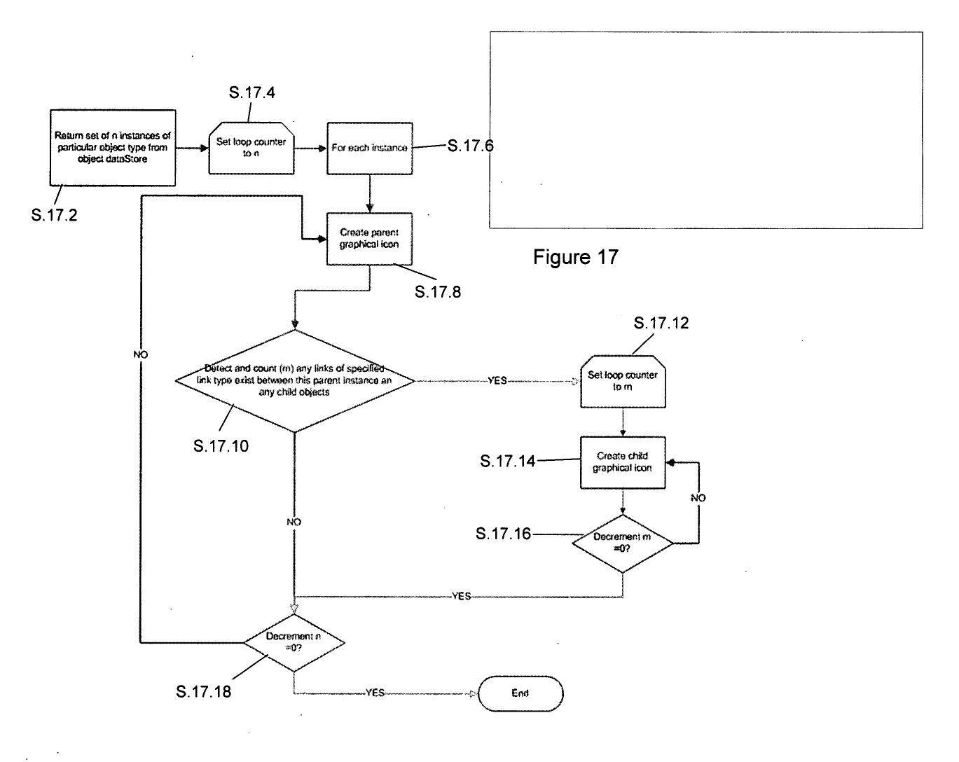

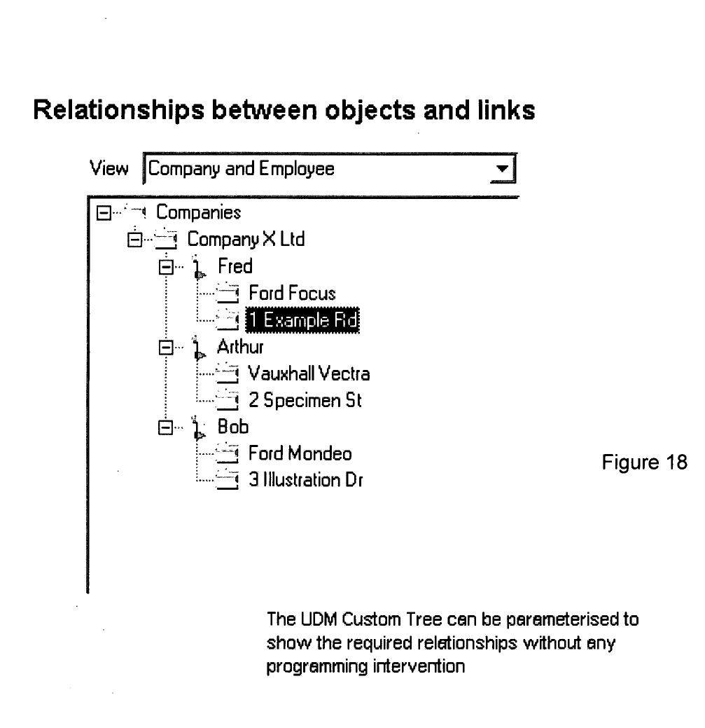

More particularly, in a further embodiment the storage of relationship data in the form of the link data store enables a graphical representation of the data stored in the database to be quickly generated in tree form. An example of such a graphical representation for the data set used in the example is shown in FIG. 18. Here it will be seen that each object is represented by a node in a graphical tree structure, and the links between objects are indicated by dotted lines. Such a graphical tree structure can be advantageously generated by simply parsing the information contained within the object and link data stores, in accordance with the procedure shown in FIG. 17.

More particularly, to generate such a graphical tree structure, at step 17.2 the object data store is searched for a particular object type to be displayed, and n instances of the object type are returned. Next, at step 17.4, a loop counter value is set equal to the count value n. Then, at step 17.6 a FOR processing loop is commenced, to process the nth entry in the link data store. The first step within the FOR processing loop is step 17.8, wherein, for the nth returned object a parent graphical icon is added into the graphical representation, representing the object. Then, at step 17.10 the link object data store is searched to detect any links of a specified link type between the parent object represented by the nth object, and any child object, and a value m is determined equal to the number of such links.

If m is not zero in value, then processing proceeds to step 17.12, wherein a second counter value is set equal to m, and then at step 17.14 a child graphical icon is created in the graphical representation, for the child object linked to by the mth link. Processing then proceeds to step 17.16, wherein the second counter value for m is decremented, and if then not zero processing returns to step 17.14. A processing loop is thus formed between steps 17.14 and 17.16, wherein a child icon is added into the display for each object pointed to by the mth link, until m is zero. In addition, a graphical link is also added between the child object and the parent object. Following step 17.16 processing proceeds to step 17.18, wherein the counter n is decremented, and checked against zero. If not zero then processing proceeds back to the top of the FOR loop, at step 17.8. If zero, then processing ends, and the graphical view should be complete.

Various modifications may be made to the above described arrangement. For example, the initial set of object instances returned for the ‘parent’ level may be limited, to speed processing time; instances that are categorised by further properties may be selected; child icons need not actually be drawn until the user expands a parent icon; and the number of child/grandchild etc. levels is entirely open and in practice is the result of determining whether a particular icon (node) has children as defined by a set of ‘link types’.

A further, second, embodiment of the invention will now be described. In this embodiment, the UDM finds application to allow for legacy data integration, so as to permit legacy data stored in two separate data silos (perhaps on different servers) to be integrated and displayed or processed by the same application. By “data silo” we mean simply an accessible database, which supports a particular application which uses the data in that database.

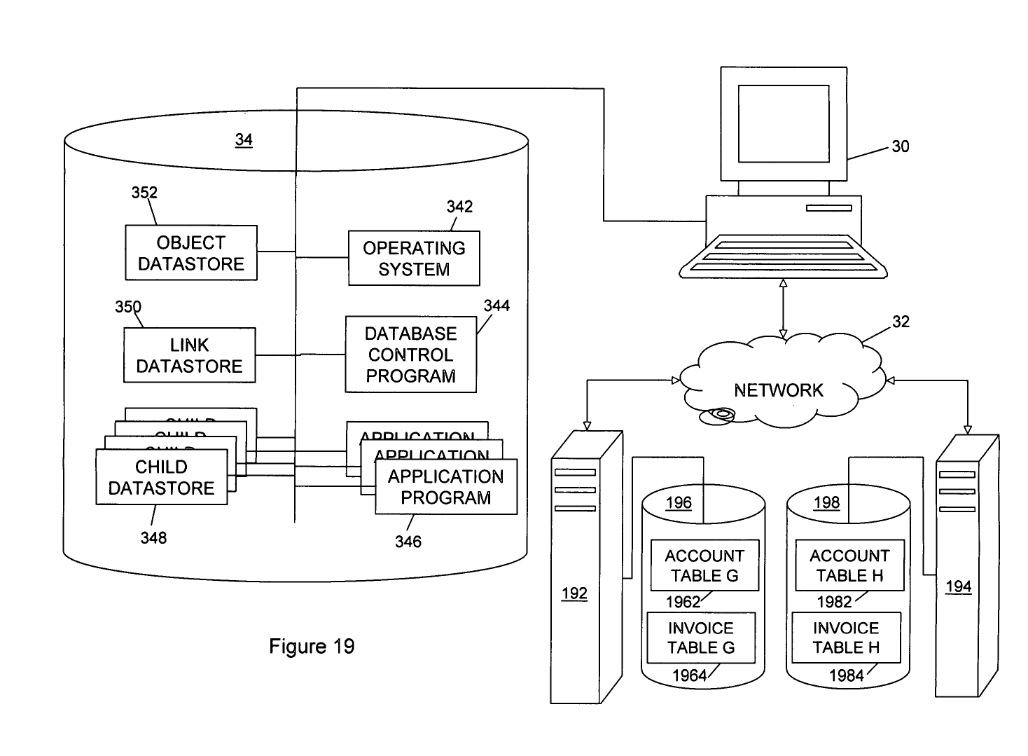

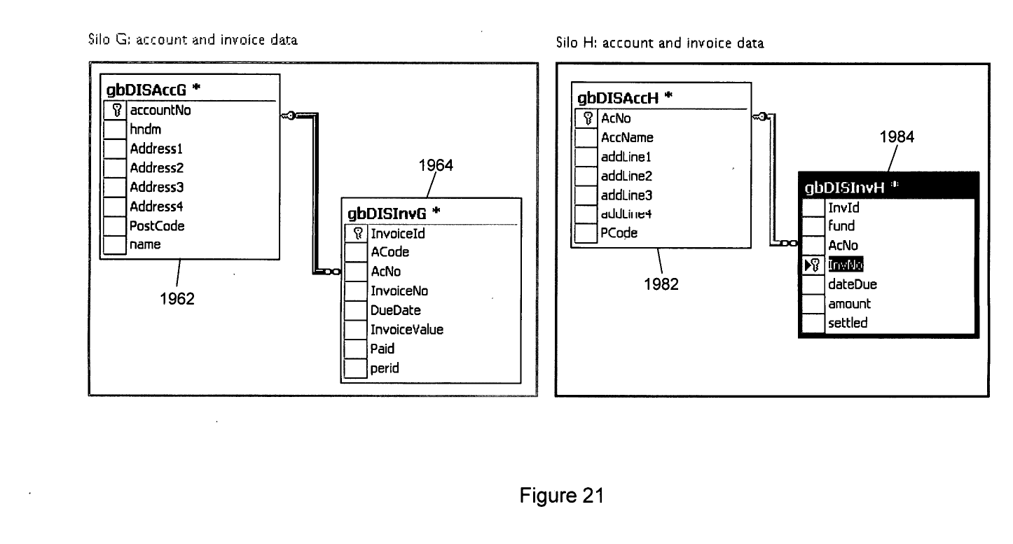

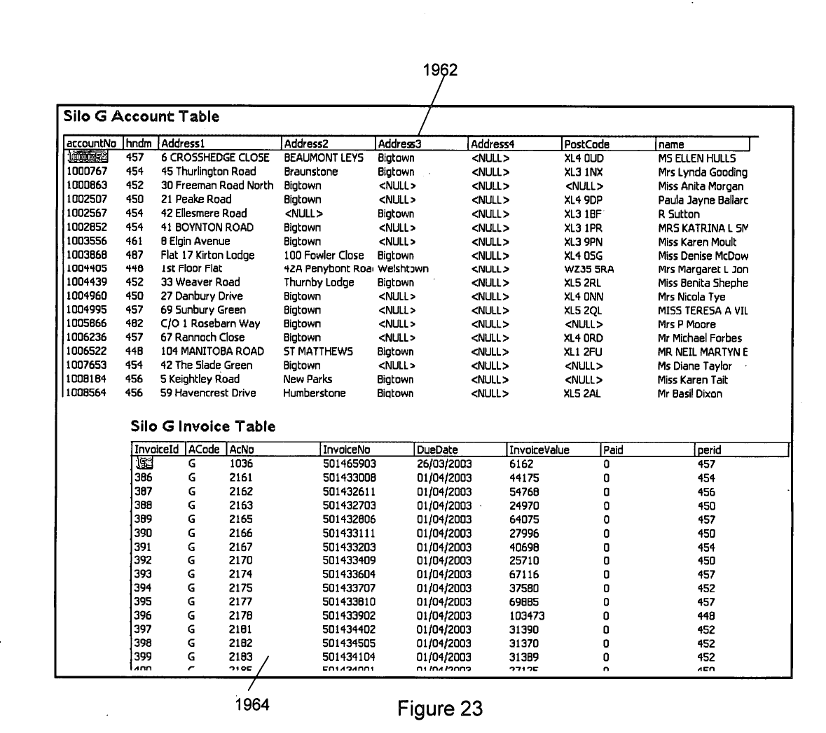

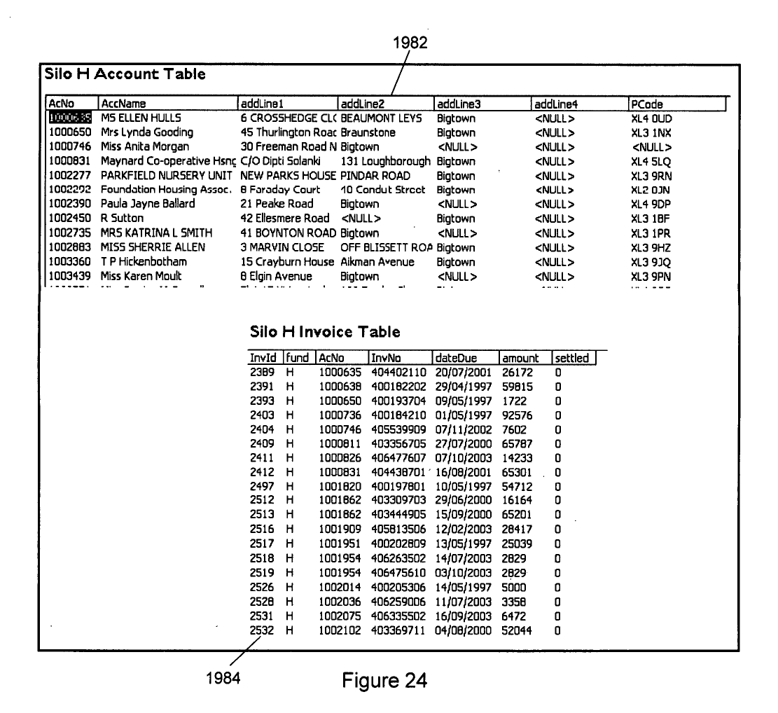

FIG. 19 illustrates a system embodying the UDM applied to this situation. More particularly, a computer system 30 provided with a computer readable storage medium 34 as described previously with respect to FIG. 3 is connected via the network 32 to a first server 192, and a second server 194. Each of the servers 192 and 194 are provided with their own data silos 196 and 198 respectively. Stored on each of these data silos are legacy databases which we will call “G” and “H”. In particular, on storage medium 196 for server 192, an account database table G 1962 is stored as is an invoice table G 1964. Similarly, on the storage medium 198 for the server 194, an account table H 1982 and an invoice database table H 1984 is also stored. FIG. 21 illustrates the structure of the account and invoice database tables in the silos G and H, and FIGS. 23 and 24 are screen shots showing sample rows of data from the two systems. The rows within the screen shots are selected to show the duplicate entries for a person modelled in the system, being a “Ms Ellen Hulls”. In particular, in the silo G account table 1962, Ms Ellen Hulls is modelled as account number 1000752, whereas in the silo H account table 1982, Ms Ellen Hulls is modelled as account number 1000635. As an example for the purposes of description of the embodiment, let us say that the specific requirement of the system is to integrate this respective data about “Ms Hulls” so that her total debt to the organisation can be seen in one view. Furthermore, this view is preferably of “live” data that is still maintained by the legacy systems.

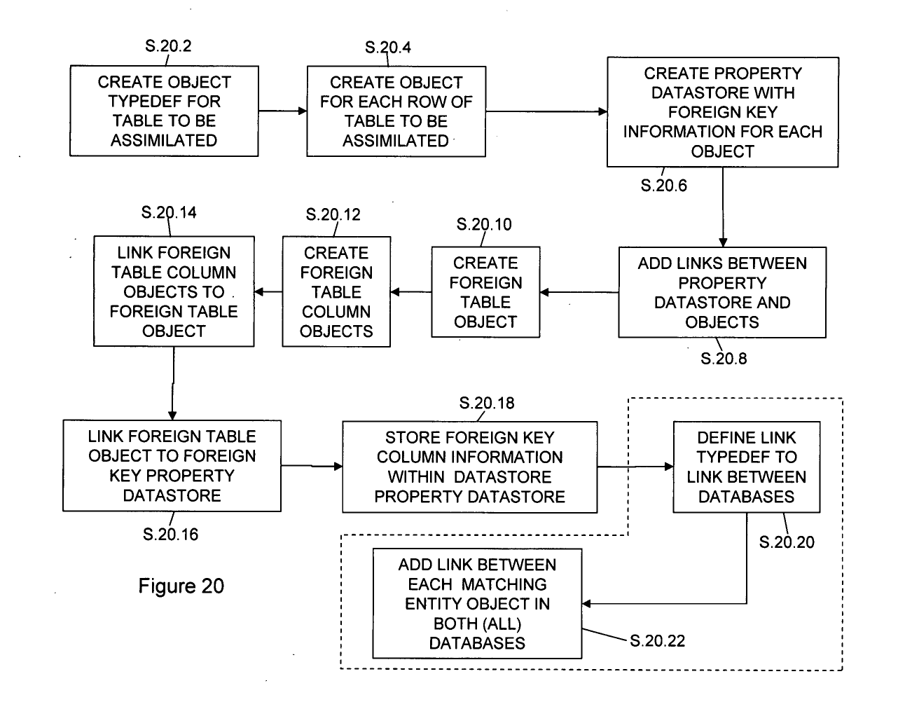

In order to produce such a unified view, the computer system 30 under control of the database control program 344, performs the steps set out in FIG. 20. These steps essentially relate to two tasks, the first being to assimilate the structure of the relevant section of the legacy silos, and the second being to match records in the different silos that relate to the same person. In FIG. 20 the steps relating to the matching function are shown within the dotted box.

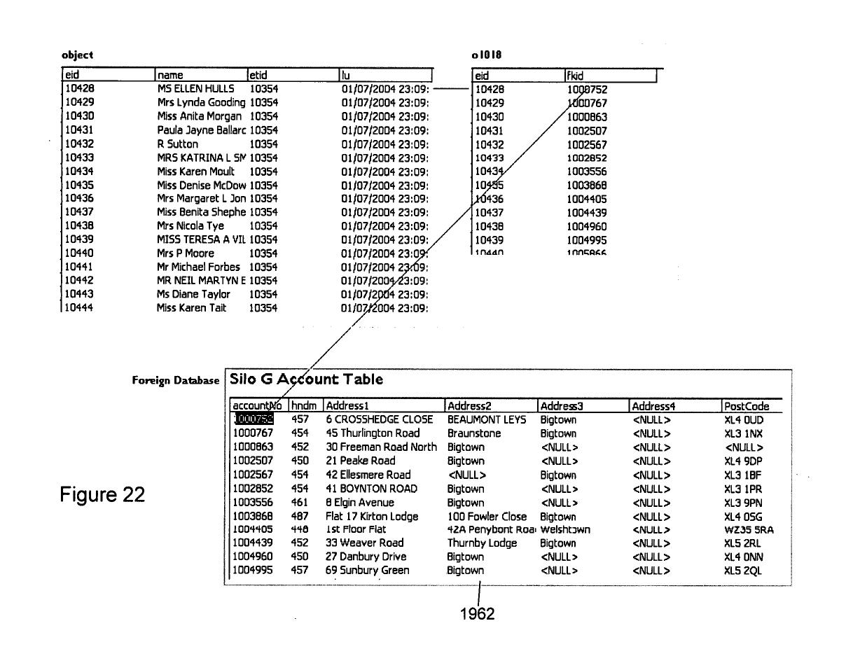

With reference to FIG. 20, at step 20.2 the first step in assimilation is to create a type of object which represents the real world entity in the legacy database to be assimilated. So, for example, for the silo G account table 1962, an object type definition for the rows of the silo G account table is created, and then at step 20.4 an object is created in the object data store 352 for each row of the table to be assimilated. Thus, for example, as shown in FIG. 22, the object data store contains an object for “Ms Ellen Hulls” as well as for each of the other people represented by rows within the silo G account table.

The next step at step 20.6 is to create a property data store for the object type created at step 20.2, the property data store containing foreign key information for each object, which is the key information needed to find a particular record in the foreign database table (being the silo G account table 1962, in this example). At step 20.8 links are then added between the entries in the foreign key property data store and the objects created at step 20.4. Then, at step 20.10 a foreign table object is defined and created, to represent the actual silo G account table 1962. Of course, when other foreign legacy tables are being integrated, objects of this type would be respectively instantiated for each table. In order to model the internal structure of the foreign table which is being assimilated, at steps 20.12 objects are defined and created to keep track of the column structure within the foreign table being assimilated. At 20.14 the foreign table column objects are linked to the foreign table object by links of the type “column for table”. This link type will have been defined as an object in advance, and the links are stored within the link data store 350.

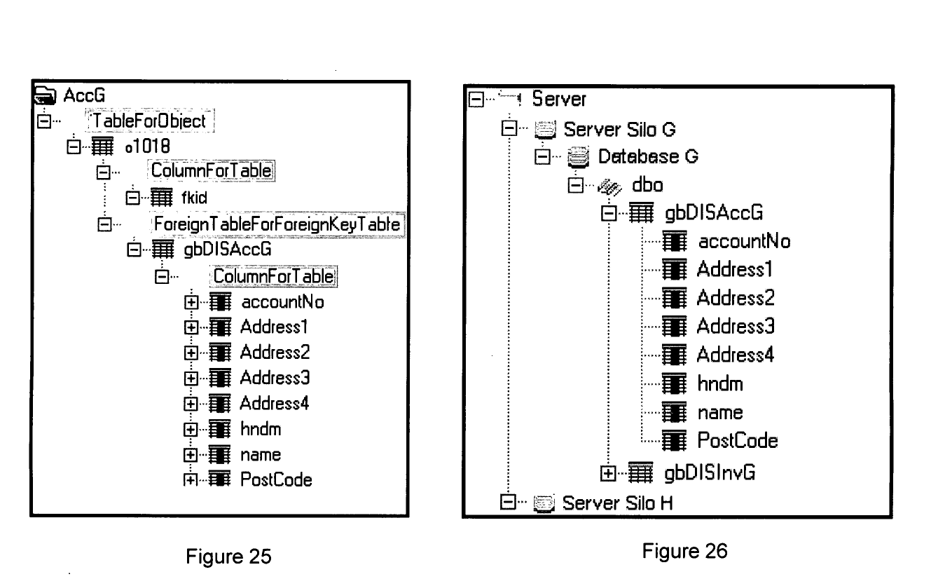

At step 20.16 the foreign table object is linked to the foreign key property data store, by a link of type “foreign table for foreign key table” which is defined within the object data store. The various objects and links thus created are illustrated in a graphical representation in FIG. 25, which for clarity is shown as a hierarchical tree view, rather than showing rows from database tables. In this view the nodes enclosed in a box are links (i.e. rows in the link data store), and the other nodes are entries in the object data store. It should be noted that the terms “property” and “data store” are equivalent terms to “column” and “table” in this view.

FIG. 22 is a screen shot illustrating the effect of the various definitions of the objects and links, and illustrates how the UDM representation can then reference the foreign table. In particular, the objects which act as pointers to the “foreign” table are visible in the object data store, and the data store o1018 (the foreign key information property data store) is illustrated as having a property called “FKid” which contains the key column values in the foreign table being assimilated, and which enable the UDM to find the appropriate records.

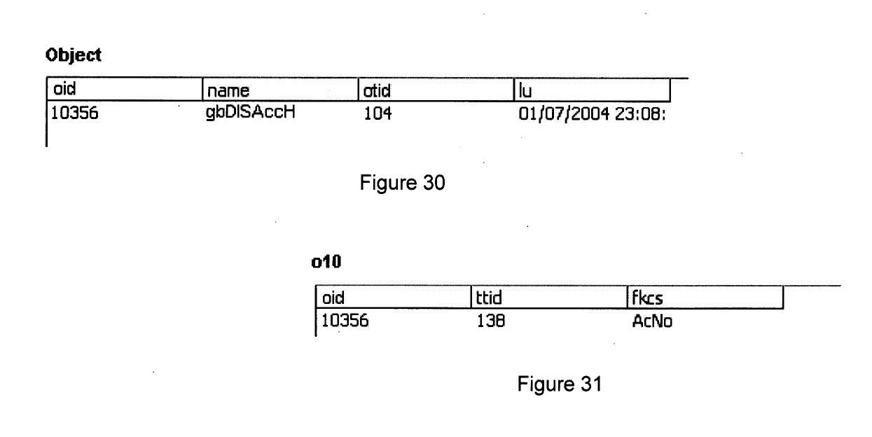

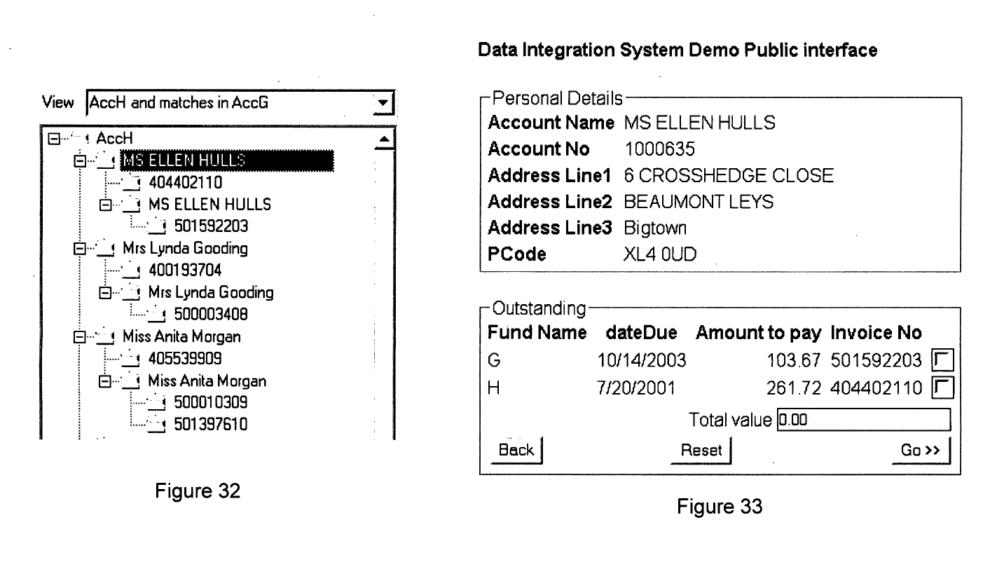

FIGS. 30 and 31 illustrate how the UDM knows which column in the foreign table is the key column (i.e. which column in the foreign table the “FKid” value refers to). In particular, a child data store “o10”, which is the property data store for objects of type “data store”, stores key column information relating to the foreign table object for the foreign table being assimilated. In this example, the foreign key column information is shown stored for the foreign table object for the silo H account table. Data store “o10” would also contain an entry for the silo G account table object, and would have “account no.” as the foreign key column entry. Relating the above to FIG. 20, this foreign key column information is stored within the data store property data store at step 20.18. Step 20.18 concludes the assimilation step.

It should be noted that the above assimilation steps would be performed for each foreign table that is being assimilated, such that in the example they would be performed for each of the invoice and account tables for each of silos G and H. FIG. 26 illustrates how the UDM assimilates the relationships between servers, databases, and their internal structure, shown in a graphical tree form (NB in this tree the actual links have been suppressed).

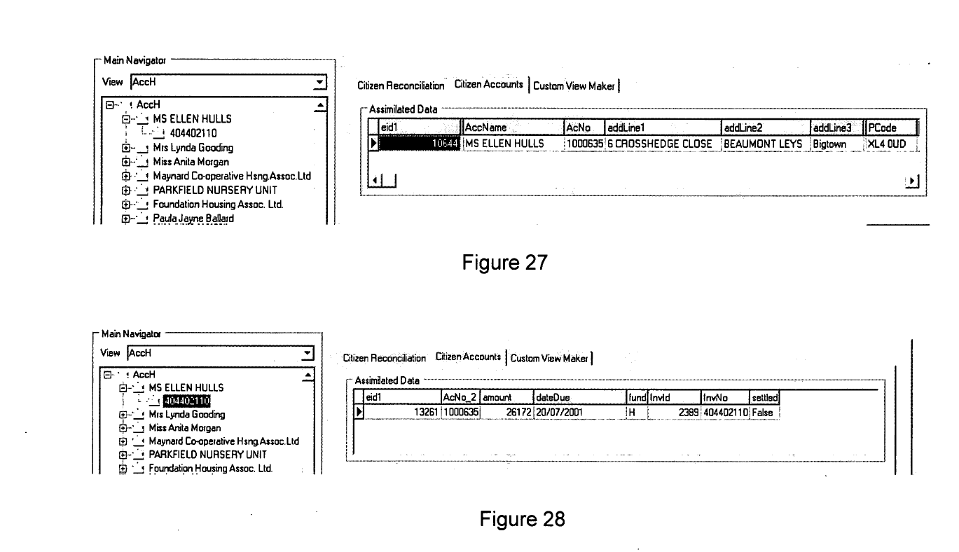

From the above described operation, having assimilated the foreign database table, it is then possible for the UDM to trace a route from an object in the UDM (for instance the Ms Ellen Hulls object), to the actual record in the foreign table where her personal details are held, in columns like “acc name”, “acc number”, “ad line 1”, etc. etc. FIG. 27 illustrates a graphical user interface illustrating how the UDM is able to pull this information from the legacy databases, and display it to a user.

Additionally, it should be noted that the foreign key relationship between the account tables and the invoice tables in any particular data silo is modelled by a link of type “inv G for acc G” or “inv H for acc H” which is declared as a link type within the object data store, and links added within the link data store. By using such a link, the relationship between the invoice and the account foreign tables can be represented, and data pulled from the appropriate silos. FIG. 28 illustrates how invoice data can be represented in a tree view, and displayed within a graphical user interface.

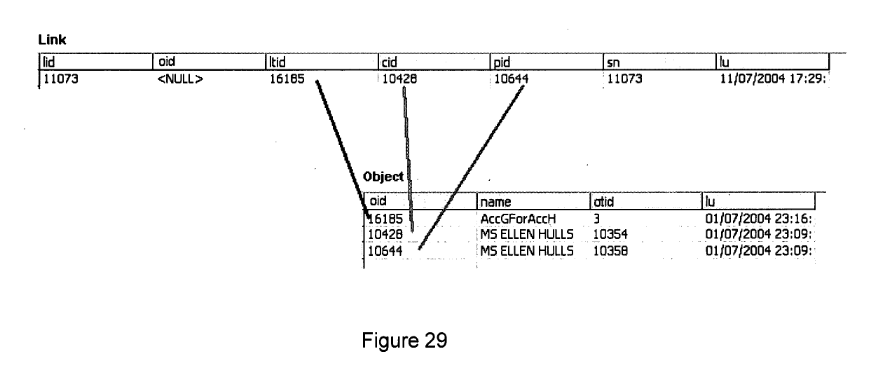

Once the legacy database tables have been assimilated into the UDM, it is a relatively simple matter to create an entry in the link data store that shows the match between the two assimilated databases. FIG. 29 illustrates this. More particularly, a link type definition “AccGForAccH” is defined, and stored within the object data store. Then, a link between each matching entity object is added to the link data store, linking the respective objects in the object data store representing the same person in each assimilated foreign database table. This is illustrated in FIG. 9, wherein the two objects created for the person “Ms Ellen Hulls” in each of the account tables G and H are linked by virtue of link ID “11073”.

Since the entries in the object data store for each of the matched clients can be resolved to live data in the legacy data silos, the UDM can integrate these systems and present the data in a unified view. FIG. 33 shows an example web interface wherein data from the individual silos G and H have been integrated and displayed within the same graphical user interface.

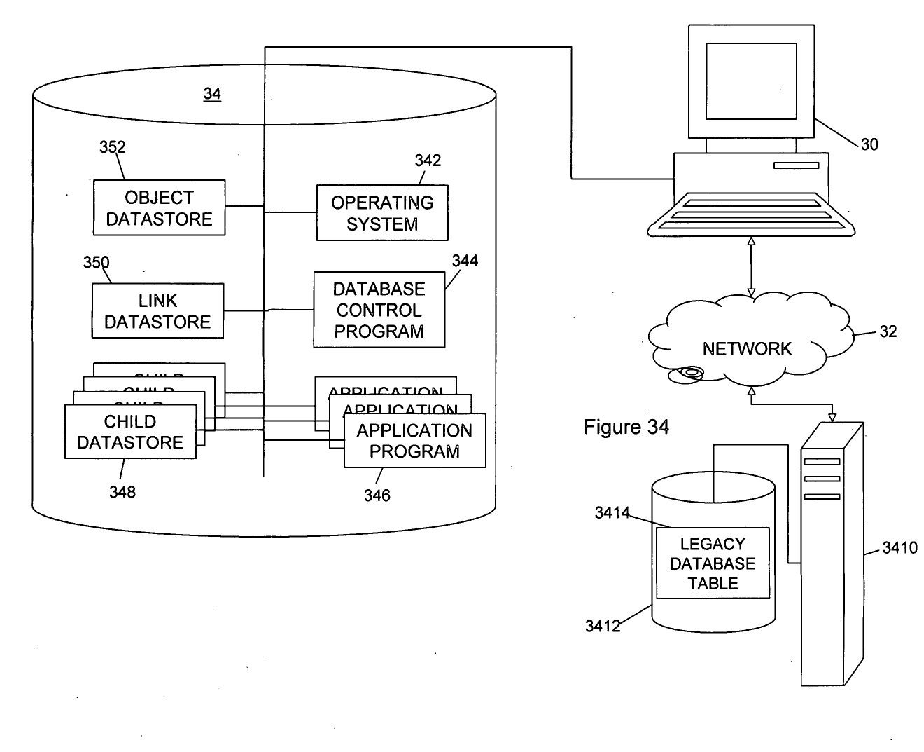

A third embodiment of the present invention will now be described with respect to FIGS. 34 to 39. This embodiment builds upon the second embodiment, in that it follows from the ability to assimilate foreign database tables used within the second embodiment. In particular, the third embodiment is concerned with using the UDM to perform incremental data migration from a legacy database table, to a new, UDM representation.

FIG. 34 illustrates a computer system provided by the third embodiment of the invention. In particular, the computer system 30 is provided with a computer readable storage medium 34, which is identical to that described previously with respect to FIG. 3, and which has functionally identical or similar programs stored thereon. The computer system 30 is arranged to communicate with a server 3410 over the network 32. The server 3410 has a computer readable storage medium 3412, upon which is stored a legacy database table 3414, containing data that is to be migrated to a UDM system.

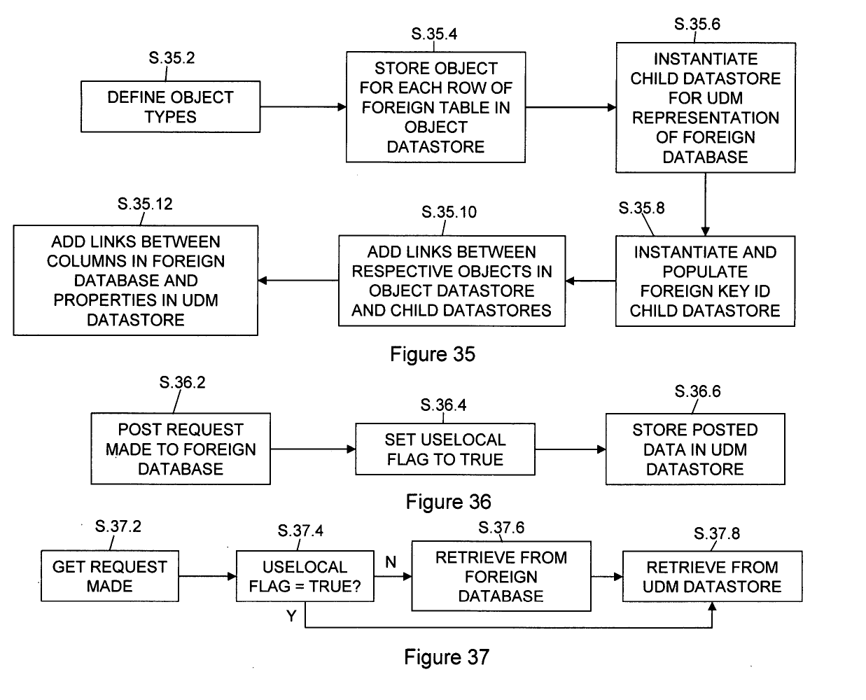

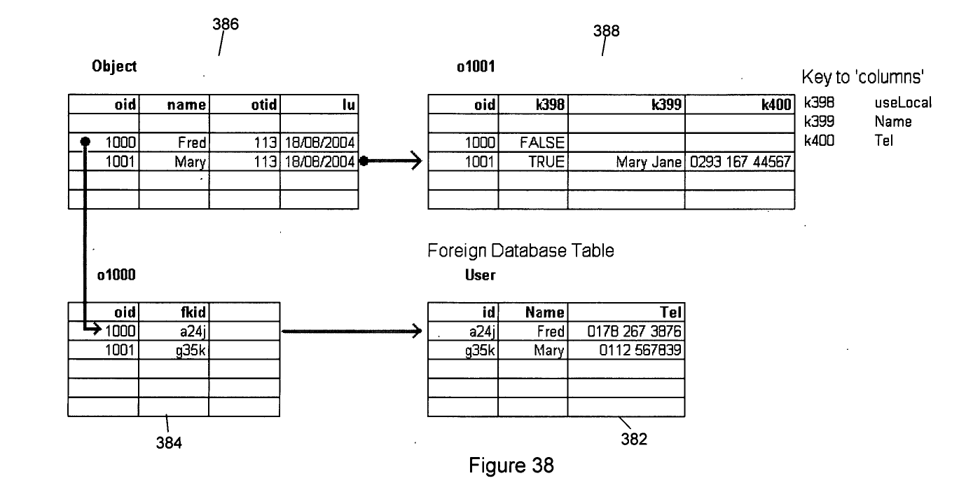

FIG. 38 illustrates the migration of data from a foreign database table 382, to a new UDM data store “o1001”, 388. More particularly, FIG. 35 illustrates the process performed in setting up the UDM to permit incremental data migration. Firstly, at step 35.2 object type definitions are made in the object data store, to define object types for objects to represent the entities represented in the foreign database table. Then, at step 35.4, objects of the defined object type are stored in the object data store, being one object for each row of the foreign table. For example, object data store 386 illustrates that objects “Fred” and “Mary” have been stored, corresponding to the data entries for Fred and Mary in the foreign database table.

Next, at step 35.6 a child data store is instantiated to act as the UDM representation of the foreign database. In FIG. 38 this is the data store 388 (“o1001”), as discussed previously. One of the properties of this data store is column K398 i.e. “UseLocal”. When data has been successfully migrated or authenticated, this flag is set to true. This flag is used by the control software to determine whether to use this local record, or alternatively to use the foreign data record. For example, in the case of object ID “1000”, the “UseLocal” property is set to false, so data will be fetched from the foreign database. Alternatively, if data relating to this object is altered by a user, the updated value will be posted to the new record data store 388, which will be marked accordingly. This has happened in the case of record “1001”, wherein Mary's old data is no longer referenced by the UDM when fetching data for her. Instead, the data in the data store 388 is used.

This process is illustrated further in FIG. 36. More particularly, if a user makes a post request in step 36.2 to the foreign database, then this request is intercepted by the control software, and at step 36.4 the UseLocal flag in the data store 388 for that user is set to true. Then, at step 36.6 the posted data is stored in the UDM data store 388.

Returning to FIG. 35, following the creation of the data store 388, at step 35.8 a foreign key ID child data store is instantiated and populated. In FIG. 38 this is the data store 384, which contains, for each object ID within the object data store, a foreign key ID indexing the foreign database table. Once the two child data stores 384 and 388 have been instantiated and populated, at step 35.10 respective links between the objects in the child data stores and the object data store are added. Finally, at step 35.12 in order for the UDM to know which column of the foreign database maps to which column of the data store 388, links of type “new property for old column” are added to the link data store.

FIG. 37 is a flow diagram illustrating how data can be obtained from such a system. More particularly, at step 37.2 a GET request is made to access data for a particular entity, and this causes the control software to determine whether the UseLocal flag is set to true within the data store 388 for the object representing the entity for which data has been requested, at step 37.4. If the flag is set to true, then processing goes to step 37.8, wherein the data is retrieved from the UDM data store 388. Alternatively, if the UseLocal flag is set to false, then data is retrieved from the foreign database at step 37.6.

Such a system as described above allows database administrators to set up new systems that derive their data from legacy systems, but which store new values in a new system. This allows the data to be tested, the rules for migration from the old system to the new system be recorded, and once a commitment is made to use the new system, data can still be pulled on a record by record basis from the old system, but posted into the new according to the migration rules developed during testing. Moreover, if required, a set of such rules could be used to support a traditional “big bang” migration, but safe in the knowledge that its key elements had already been tested.

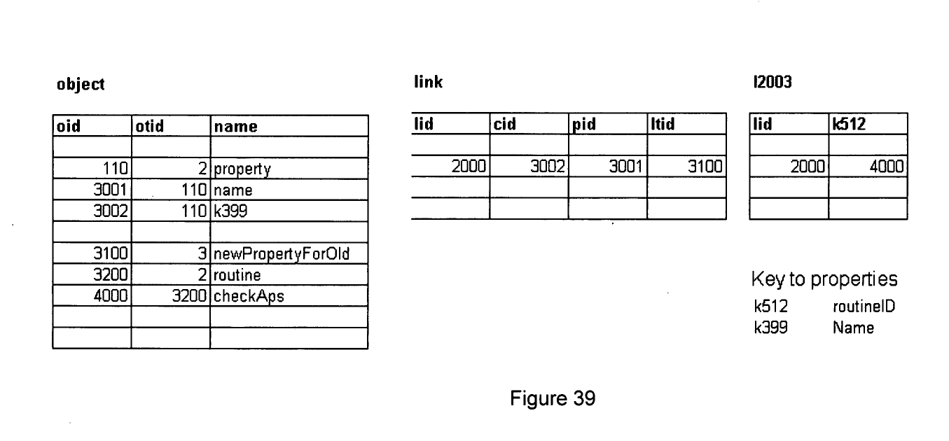

The data migration techniques provided by the third embodiment of the invention can also be used to support any data cleansing or other processing routines that might be needed. This is illustrated in FIG. 39. In FIG. 39 it can be seen that the column “name” in the legacy system is to map to “K399” (which is the property name in the UDM data store for users “o1001”). By creating an instance of the link type “new property for old”, which has its child ID equal to “3002”, and parent ID equal to “3001”, a migration rule is defined. This can be used in a number of ways. For instance, it can be used to determine where to post updated values derived from “name”. It can also be used in a mass migration exercise to determine where, in the new UDM system, to copy column values from the legacy system. Since the new data store has the UseLocal property, this could be used to determine whether to copy the old value or ignore it (because it has been updated during the incremental migration process).

Moreover, as links can also have properties, one of the properties of this link could be a “routine” i.e. a call to a software routine that, in this example, checks the data for single apostrophes and replaces them with double apostrophes. Any number of data cleansing, processing, or validation rules could be supported by such a system.

Various modifications may be made to the above-described embodiment to provide further embodiments that are encompassed by the appended claims, which define the spirit and scope of the present invention. Moreover, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A data modelling method for storing data in a database, comprising storing a plurality of data objects, each data object representing one of a group comprising: a type of entity to be modelled; an instance of an entity to be modelled; and a type of relationship between entities to be modelled; wherein each data object includes at least the same sub-set of at least one or more properties.

2. A method according to claim 1, wherein the sub-set of properties includes at least a name of the object.

3. A method according to claim 1, wherein the sub-set of properties includes at least an identity of the object.

4. A method according to claim 3, wherein the identity of the object is uniquely defined.

5. A method according to claim 1, wherein the sub-set of properties includes at least a type of the object.

6. A method according to claim 5, wherein the type of the object is defined by reference to one of the data objects representing a type of entity to be modelled.

7. A method according to claim 6, wherein the type of at least one of the data objects representing a type of entity to be modelled is defined by reference to one of the data objects representing a type of entity to be modelled, whereby a hierarchical arrangement of object types is defined and stored.

8. A method according to claim 1, and further comprising storing link objects defining instances of types of relationships between entities to be modelled, said link objects including at least the same sub-set of at least one or more properties.

9. A method according to claim 8, wherein the link object properties include at least: a link identity; a link type; and an indication of data objects representing the entities for which the relationship therebetween is modelled by the link object.

10. A method according to claim 9, wherein the link type is defined by reference to one of the data objects representing a type of relationship between entities to be modelled.

11. A method according to claim 9, wherein the indication of data objects comprises the data object identities of the data objects representing the entities for which the relationship therebetween is modelled by the link object.

12. A method according to claim 1, wherein the entities to be modelled include data storage arrangements in which said data objects and/or said link objects are stored, whereby an internal structure of said database is modelled.

13. A method according to claim 12, and further comprising storing meta-data concerning said data storage arrangements as said data objects and/or link objects.

14. A method according to claim 1 wherein said data objects are stored within a data storage arrangement of a first type, the method further comprising instantiating data storage arrangements of a second type to store further object-specific properties of the data objects.

15. A method according to claim 8, wherein said data objects are stored within a data storage arrangement of a first type, the method further comprising instantiating data storage arrangements of a second type to store further object-specific properties of the data objects, and wherein said link objects are stored within a data storage arrangement of a third type, the method further comprising instantiating data storage arrangements of a second type to store further object-specific properties of the link objects.

16. A method according to claim 15, wherein the data storage arrangement of the first type and/or the data storage arrangement of the second type and/or the data storage arrangement of the third type is a database table.

17. A database operating method comprising:
modelling data in a database by storing a plurality of data objects, each data object representing one of a group comprising: a type of entity to be modelled; an instance of an entity to be modelled; and a type of relationship between entities to be modelled; wherein each data object includes at least the same sub-set of at least one or more properties; and
applying generic database query operations to said database to retrieve data therefrom in response to a database query.

18. A method of generating a visual display of data stored in a database, comprising the steps of:—
modelling data in a database by storing a plurality of data objects, each data object representing one of a group comprising: a type of entity to be modelled;
an instance of an entity to be modelled; and a type of relationship between entities to be modelled; wherein each data object includes at least the same sub-set of at least one or more properties, and storing link objects defining instances of types of relationships between entities to be modelled, said link objects including at least the same sub-set of at least one or more properties;
using the link objects, generating a graphical arrangement of data icons representing data objects indicated by said link objects, said graphical arrangement including graphical links linking said data icons; and
displaying said graphical arrangement on a display.

19. A method according to claim 18, wherein said graphical arrangement is arranged as a hierarchical tree of data icons representing said data objects.

20. A method of integrating data relating to the same entity and stored within two or more databases, comprising the steps of:—
i) modelling the data in each database by storing a plurality of data objects, each data object representing one of a group comprising: a type of entity to be modelled; an instance of an entity to be modelled; and a type of relationship between entities to be modelled; wherein each data object includes at least the same sub-set of at least one or more properties;
ii) storing a link object defining a relationship between respective data objects instancing the data in each database relating to the same entity; and
iii) using the link object, retrieving data relating to the same entity from each database.

21. A method according to claim 20, wherein the modelling step further comprises storing a respective data object for each set of data relating to an entity to be modelled in each of the databases; and for each data object, storing a foreign key property containing an index value into the database to which the data object relates.

22. A method according to claim 21, wherein the foreign key property is stored in a data storage arrangement of the second type.

23. A method of incrementally transferring data from a database of a first type to a database of a second type, the database of the second type being arranged to model data by storing a plurality of data objects, each data object representing one of a group comprising: a type of entity to be modelled; an instance of an entity to be modelled; and a type of relationship between entities to be modelled; wherein each data object includes at least the same sub-set of at least one or more properties, the method further comprising the steps:
i) storing a data object within the database of the second type for each entity for which data is stored in the database of the first type;
ii) storing, within the database of the second type, a foreign key property for each data object to permit access to records within the database of the first type; and
iii) storing, within the database of the second type, further properties for each data object, the further properties corresponding to data relating to each entity stored within the database of the first type;
wherein said further properties are stored within said database of the second type as the data represented by the properties is changed.

24. A method according to claim 23, wherein the further properties include an indicator flag which indicates whether, for a data object, properties have been stored, wherein, when accessing data, the indicator flag is checked to determine whether to access data from the database of the first type or the second type.

25. A method according to claim 23, wherein a data processing routine is run to process data being stored as the further properties when said further properties are stored.

26. A computer program or suite of computer programs arranged such that when executed by a computer system it/they cause the computer system to store a plurality of data objects, each data object representing one of a group comprising: a type of entity to be modelled; an instance of an entity to be modelled; and a type of relationship between entities to be modelled; wherein each data object includes at least the same sub-set of at least one or more properties.

27. A computer readable storage medium storing a computer program or at least one of the suite of computer programs according to claim 26.

28. A data modelling system for storing data in a database, comprising data storage for storing a plurality of data objects, each data object representing one of a group comprising: a type of entity to be modelled; an instance of an entity to be modelled; and a type of relationship between entities to be modelled; wherein each data object includes at least the same sub-set of at least one or more properties.

29. A system according to claim 28, wherein the sub-set of properties includes at least a name of the object.

30. A system according to claim 28, wherein the sub-set of properties includes at least an identity of the object.

31. A system according to claim 30, wherein the identity of the object is uniquely defined.

32. A system according to claim 28, wherein the sub-set of properties includes at least a type of the object.

33. A system according to claim 32, wherein the type of the object is defined by reference to one of the data objects representing a type of entity to be modelled.

34. A system according to claim 33, wherein the type of at least one of the data objects representing a type of entity to be modelled is defined by reference to one of the data objects representing a type of entity to be modelled, whereby a hierarchical arrangement of object types is defined and stored.

35. A system according to claim 28, and further comprising link object storage arranged to store link objects defining instances of types of relationships between entities to be modelled, said link objects including at least the same sub-set of at least one or more properties.

36. A system according to claim 35, wherein the link object properties include at least: a link identity; a link type; and an indication of data objects representing the entities for which the relationship therebetween is modelled by the link object.

37. A system according to claim 36, wherein the link type is defined by reference to one of the data objects representing a type of relationship between entities to be modelled.

38. A system according to claims 36, wherein the indication of data objects comprises the data object identities of the data objects representing the entities for which the relationship therebetween is modelled by the link object.

39. A system according to claim 28, wherein the entities to be modelled include data storage arrangements in which said data objects and/or said link objects are stored, whereby an internal structure of said database is modelled.

40. A system according to claim 39, and further comprising meta-data storage for storing meta-data concerning said data storage arrangements as said data objects and/or link objects.

41. A system according to claim 28 wherein said data objects are stored within a data storage arrangement of a first type, the system further comprising means for instantiating data storage arrangements of a second type to store further object-specific properties of the data objects.

42. A system according to claim 35, wherein said data objects are stored within a data storage arrangement of a first type, the system further comprising means for instantiating data storage arrangements of a second type to store further object-specific properties of the data objects, and wherein said link objects are stored within a data storage arrangement of a third type, the system further comprising means for instantiating data storage arrangements of a second type to store further object-specific properties of the link objects.

43. A system according to claim 42, wherein the data storage arrangement of the first type and/or the data storage arrangement of the second type and/or the data storage arrangement of the third type is a database table.

44. A database control system arranged in use to:
i) model data in a database by storing a plurality of data objects, each data object representing one of a group comprising: a type of entity to be modelled; an instance of an entity to be modelled; and a type of relationship between entities to be modelled; wherein each data object includes at least the same sub-set of at least one or more properties; and
ii) apply generic database query operations to said database to retrieve data therefrom in response to a database query.

45. A system for generating a visual display of data stored in a database, comprising:—
a database controller arranged in use to model data in a database by storing a plurality of data objects, each data object representing one of a group comprising: a type of entity to be modelled; an instance of an entity to be modelled; and a type of relationship between entities to be modelled; wherein each data object includes at least the same sub-set of at least one or more properties, and storing link objects defining instances of types of relationships between entities to be modelled, said link objects including at least the same sub-set of at least one or more properties; and
a graphical display arranged in use to:—
i) using the link objects, generate a graphical arrangement of data icons representing data objects indicated by said link objects, said graphical arrangement including graphical links linking said data icons; and
ii) display said graphical arrangement on a display means.

46. A system according to claim 45, wherein said graphical display is arranged as a hierarchical tree of data icons representing said data objects.

47. A system for integrating data relating to the same entity and stored within two or more databases, comprising:—
i) a database controller arranged in use to model the data in each database by storing a plurality of data objects, each data object representing one of a group comprising: a type of entity to be modelled; an instance of an entity to be modelled; and a type of relationship between entities to be modelled; wherein each data object includes at least the same sub-set of at least one or more properties; and
ii) link storage for storing a link object defining a relationship between respective data objects instancing the data in each database relating to the same entity;
said database controller being further arranged in use to retrieve data relating to the same entity from each database using the link object.

48. A system according to claim 47, wherein the database controller further comprises data object storage for storing a respective data object for each set of data relating to an entity to be modelled in each of the databases; and foreign key storage for storing, for each data object, a foreign key property containing an index value into the database to which the data object relates.

49. A system according to claim 47, wherein the foreign key property is stored in a data storage arrangement of the second type.

50. A system for incrementally transferring data from a database of a first type to a database of a second type, the database of the second type being arranged to model data by storing a plurality of data objects, each data object representing one of a group comprising: a type of entity to be modelled; an instance of an entity to be modelled; and a type of relationship between entities to be modelled; wherein each data object includes at least the same sub-set of at least one or more properties, the system comprising:
a database controller arranged in use to:—
i) store a data object within the database of the second type for each entity for which data is stored in the database of the first type;
ii) store, within the database of the second type, a foreign key property for each data object to permit access to records within the database of the first type; and
iii) store, within the database of the second type, further properties for each data object, the further properties corresponding to data relating to each entity stored within the database of the first type;
wherein said further properties are stored within said database of the second type as the data represented by the properties is changed.

51. A system according to claim 50, wherein the further properties include an indicator flag which indicates whether, for a data object, properties have been stored, wherein when accessing data the indicator flag is checked to determine whether to access data from the database of the first type or the second type.

52. A system according to claim 50, wherein a data processing routine is run to process data being stored as the further properties when said further properties are stored.
